(19) United States
(12) Patent Application Publication
(10) Pub. No.: US 2020/0012350 A1
(43) Pub. Date: Jan. 9, 2020

(54) SYSTEMS AND METHODS FOR REFINED GESTURE RECOGNITION

(71) Applicant: YouSpace, Inc., Santa Clara, CA (US)

(72) Inventor: Terence Tay, Raleigh, NC (US)

(21) Appl. No.: 16/029,617

(22) Filed: Jul. 8, 2018

(51) Int. Cl. G06F 3/01; G06N 5/00

(52) U.S. Cl. CPC G06F 3/017; G06N 5/003; G06F 3/011

(57) ABSTRACT

Various of the disclosed embodiments related to improved processing systems for human-computer interaction. Particularly, various of the disclosed embodiments employ heuristics, alone or in combination, to more readily identify user gestures and their characteristics. For example, some embodiments employ a “gesture zone” heuristic, boundary planes for angle adjustment heuristic, and average velocity measurements heuristic, to more readily detect the performance of a swipe gesture and the direction of the gesture. Some embodiments may also use the heuristics in connection with a gesture state machine for assessing the user's progress in performing a gesture.

### TECHNICAL FIELD

Various of the disclosed embodiments relate to automated gesture recognition processing for user-device interactions.

### BACKGROUND

Human-computer interaction (HCI) systems are becoming increasingly prevalent in our society. This increasing prevalence has precipitated an evolution in the nature of such interactions. Punch cards have been surpassed by keyboards, which were themselves complemented by mice, which are themselves now complemented by touch screen displays, etc. Today, various machine vision approaches may even facilitate visual, rather than the mechanical, user feedback. For example, machine vision techniques may allow computers to interpret images from their environment so as to recognize user faces and gestures. These systems may rely upon grayscale or color images exclusively, depth data exclusively, or a combination of both. Examples of senor systems that may be used by these systems include, e.g., the Microsoft Kinect™ Intel RealSense™, Apple PrimeSense™, Structure Sensor™, Velodyne HDL-32E LiDAR™, Orbbec Astra™, etc.

While users increasingly desire to interact with these systems, such interactions may be hampered by ineffective system recognition of user gestures. Failing to recognize a gesture's performance may cause the user to assume that the system is not configured to recognize such gestures. Perhaps more frustratingly, misinterpreting one gesture for another may cause the system to perform an undesirable operation. Systems unable to distinguish these subtle differences in user gesture movement cannot accurately infer the user's intentions. In addition, an inability to overcome this initial interfacing difficulty restricts the user's access to any downstream functionality of the system. For example, poor identification and reporting of gestures prevents users from engaging with applications running on the system as intended by the application designer. Consequently, poor gesture recognition limits the system's viability as a platform for third party developers. It may be especially difficult to recognize “swipe” hand gestures given the wide variety of user sizes, habits, and orientations relative to the system.

Consequently, there exists a need for refined gesture recognition systems and methods which consistently identify user gestures, e.g., swipe gestures. Such consistency should be accomplished despite the many obstacles involved, including the disparate character of user movements, disparate user body types, variable recognition contexts, variable recognition hardware, etc.

### BRIEF DESCRIPTION OF THE DRAWINGS

Various of the embodiments introduced herein may be better understood by referring to the following Detailed Description in conjunction with the accompanying drawings, in which like reference numerals indicate identical or functionally similar elements:

FIG. 1 is a series of schematic use case diagrams illustrating situations in which various of the disclosed embodiments may be implemented;

FIG. 2 is a schematic diagram illustrating an example wide-screen display with a multi-angled depth sensor housing as may be used in conjunction with some embodiments;

FIG. 3 is a schematic diagram illustrating an example projected display with a multi-angled depth sensor housing as may be used in conjunction with some embodiments;

FIG. 4A is a head-on schematic view of the composite display with a depth sensor housing as may be used in conjunction with some embodiments; FIG. 4B is a top-down schematic view of the composite display with a depth sensor housing as may be used in conjunction with embodiments; FIG. 4C is a side schematic view of the composite display with a depth sensor housing as may be used in conjunction with some embodiments;

FIG. 5 is a series of schematic perspective and side views of example depth data as may be used in some embodiments;

FIG. 6 is a series of schematic views illustrating data isolation via plane clipping as may be applied to the depth data of FIG. 5 in some embodiments;

FIG. 7 is an example component classification as may be applied to the isolated data of FIG. 6 in some embodiments;

FIG. 8 is an example full-body depth value classification as may be applied to captured depth data in some embodiments;

FIG. 9 is a block diagram illustrating an example modular software/firmware/hardware implementation which may be used to perform depth data processing operations in some embodiments;

FIG. 10 is a flow diagram illustrating some example depth data processing operations as may be performed in some embodiments;

FIG. 11 is a schematic block diagram illustrating three heuristic factors facilitating improved swipe gesture recognition within the gesture recognition block 925 of FIG. 9, in some embodiments;

FIG. 12A is a schematic diagram of an example composite display with a multi-angled depth sensor housing of FIG. 4, including a gesture box, as may be used in conjunction with some embodiments; FIG. 12B is a schematic diagram of the example composite display of FIG. 12A, but with an arbitrary-shaped gesture box, or gesture zone, as may be used in conjunction with some embodiments;

FIG. 13A is a schematic representation of an example gesture box as used in FIG. 13B; FIG. 13B is a series of side and top-down schematic views of a user interacting with an interface using the gesture box of FIG. 13A, as may occur in various embodiments; FIG. 13C is a schematic diagram illustrating placement of a gesture box relative to a user's shoulder (also shown for reference in FIG. 15F), as may occur in various embodiments;

FIG. 14A is a schematic diagram illustrating an example gesture breakdown into “Idle,” “Prologue,” “Action,” and “Epilogue” phases as may be used in some embodiments; FIG. 14B is a schematic diagram illustrating a series of user gesture motions during each of the phases in FIG. 14A relative to a gesture box during an example “swipe” gesture, as may occur in some embodiments; FIG. 14C is a schematic diagram illustrating successive user gestures relative to a gesture box, as may occur in some embodiments;

FIG. 15A is a schematic diagram illustrating example boundary-crossings relative to a user's body, as may be used for detecting swipe gestures in some embodiments; FIG. 15B is a schematic diagram illustrating an example angle-division for gesture recognition, as may be used in some embodiments; FIG. 15C is a schematic diagram illustrating example angle adjustments to the angle division of FIG. 15B following a vertical boundary crossing, as may be used in some embodiments; FIG. 15D is a schematic diagram illustrating example angle adjustments to the angle division of FIG. 15B following a horizontal boundary crossing, as may be used in some embodiments; FIG. 15E is a schematic diagram illustrating example angle adjustments to the angle division of FIG. 15B following a vertical boundary crossing and a horizontal boundary crossing, as may be used in some embodiments; and FIG. 15F is a schematic diagram illustrating placement of a gesture box relative to a user's shoulder, as may occur in some embodiments;

FIG. 16 is a flow diagram illustrating operations in an example gesture history management process as may be implemented in some embodiments;

FIG. 17 is a flow diagram illustrating various operations in an example gesture detection process as may be implemented in some embodiments;

FIG. 18 is a schematic diagram of a gesture history buffer as may be used in some embodiments;

FIG. 19 is a flow diagram illustrating operations in an example gesture history velocity calculation process, as may be implemented in some embodiments;

FIG. 20A is a schematic diagram illustrating items in an example gesture history as may be used in conjunction with the operations of FIG. 20B; FIG. 20B is a flow diagram illustrating operations in an example prologue start detection process, as may be implemented in some embodiments;

FIG. 21A is a flow diagram illustrating operations in an example swipe epilogue detection process as may be implemented in some embodiments; FIG. 21B is a flow diagram illustrating operations in an example pointing epilogue detection process as may be implemented in some embodiments;

FIG. 22A is a schematic diagram illustration of items in an example gesture history as may be used in conjunction with the operations of FIG. 22B; FIG. 22B is a flow diagram illustrating operations in an example stationary hand determination process, as may be implemented in some embodiments;

FIG. 23 is a schematic diagram illustrating successive iterations of a sliding window over items in an example gesture history as may be performed in conjunction with the operations of FIG. 24;

FIG. 24 is a flow diagram illustrating operations in an example swipe epilogue prediction process, as may be implemented in some embodiments;

FIG. 25 is a flow diagram illustrating operations in an example boundary consideration process, as may be implemented in some embodiments;

FIG. 26A is a schematic illustration of training and test feature vector datasets as may be used in some embodiments; FIG. 26B is a schematic diagram illustrating elements in an example feature vector as may be used for machine learning applications in some embodiments; and

FIG. 27 is a block diagram of an example computer system as may be used in conjunction with some of the embodiments.

The specific examples depicted in the drawings have been selected to facilitate understanding. Consequently, the disclosed embodiments should not be restricted to the specific details in the drawings or the corresponding disclosure. For example, the drawings may not be drawn to scale, the dimensions of some elements in the figures may have been adjusted to facilitate understanding, and the operations of the embodiments associated with the flow diagrams may encompass additional, alternative, or fewer operations than those depicted here. Thus, some components and/or operations may be separated into different blocks or combined into a single block in a manner other than as depicted. The embodiments are intended to cover all modifications, equivalents, and alternatives falling within the scope of the disclosed examples, rather than limit the embodiments to the particular examples described or depicted.

### DETAILED DESCRIPTION

### Example Use Case and Architecture Overviews

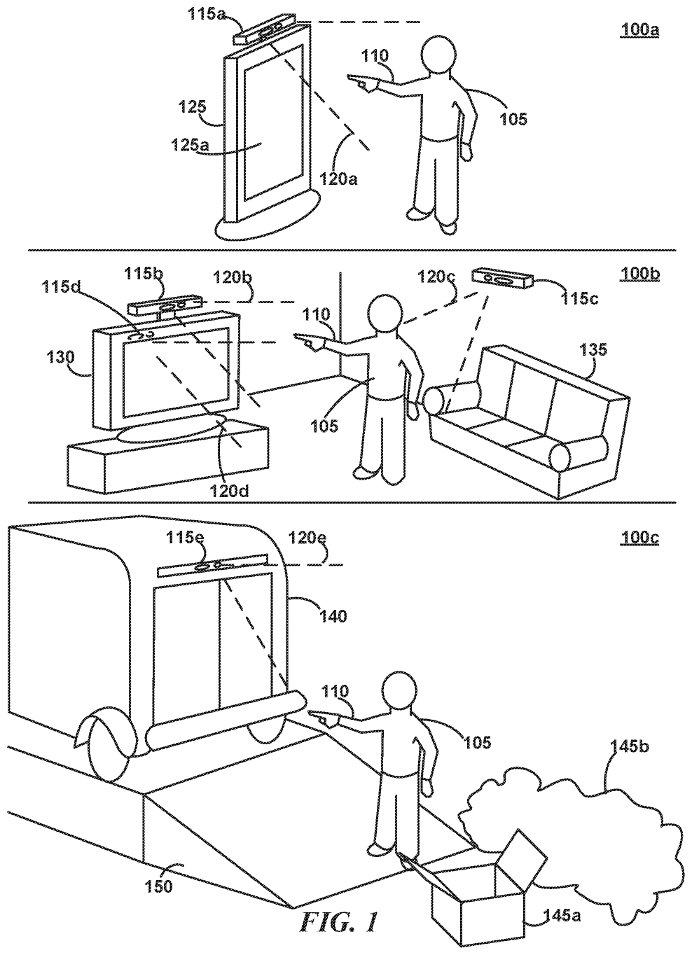

Various of the disclosed embodiments may be used in conjunction with a mounted or fixed depth camera system to detect, e.g. user gestures. FIG. 1 is a series of use case diagrams illustrating various situations 100a-c in which various of the disclosed embodiments may be implemented. In situation 100a, a user 105 is standing before a kiosk 125 which may include a graphical display 125a. Rather than requiring the user to physically touch items of interest on the display 125a, the system may allow the user to “point” or “gesture” at the items and to thereby interact with the kiosk 125.

A depth sensor 115a may be mounted upon or connected to or near the kiosk 125 so that the depth sensor's 115a field of depth capture 120a (also referred to as a “field of view” herein) encompasses gestures 110 made by the user 105. Thus, when the user points at, e.g., an icon on the display 125a by making a gesture within the field of depth data capture 120a the depth sensor 115a may provide the depth values to a processing system, which may infer the selected icon or operation to be performed. The processing system may be configured to perform various of the operations disclosed herein and may be specifically configured, or designed, for interfacing with a depth sensor (indeed, it may be embedded in the depth sensor, or vice versa, in some embodiments). Accordingly, the processing system may include hardware, firmware, software, or a combination of these components. The processing system may be located within the depth sensor 115a, within the kiosk 125, at a remote location, etc. or distributed across locations. In some embodiments, the applications running on the kiosk 125 may simply receive an indication of the selected icon and may not be specifically designed to consider whether the selection was made via physical touch vs. depth based determinations of the selection. Thus, the depth sensor 115a and the processing system may be an independent product or device from the kiosk 125 in some embodiments.

In situation 100b, a user 105 is standing in a home environment which may include one or more depth sensors 115b, 115c, and 115d each with their own corresponding fields of depth capture 120b, 120c, and 120d respectively. Depth sensor 115b may be located on or near a television or other display 130. The depth sensor 115b may be used to capture gesture input from the user 105 and forward the depth data to an application running on or in conjunction with the display 130. For example, a gaming system, computer conferencing system, etc. may be run using display 130 and may be responsive to the user's 105 gesture inputs. In contrast, the depth sensor 115c may passively observe the user 105 as part of a separate gesture or behavior detection application. For example, a home automation system may respond to gestures made by the user 105 alone or in conjunction with various voice commands. In some embodiments, the depth sensors 115b and 115c may share their depth data with a single application to facilitate observation of the user 105 from multiple perspectives. Obstacles and non-user dynamic and static objects, e.g. couch 135, may be present in the environment and may or may not be included in the fields of depth capture 120b-d.

Note that while the depth sensor may be placed at a location visible to the user 105 (e.g., attached on top or mounted upon the side of televisions, kiosks, etc. as depicted, e.g., with sensors 115a-c) some depth sensors may be integrated within another object. Such an integrated sensor may be able to collect depth data without being readily visible to user 105. For example, depth sensor 115d may be integrated into television 130 behind a one-way mirror and used in lieu of sensor 115b to collect data. The one-way mirror may allow depth sensor 115d to collect data without the user 105 realizing that the data is being collected. This may allow the user to be less self-conscious in their movements and to behave more naturally during the interaction.

While the depth sensors 115a-d may be positioned parallel to a wall, or with depth fields at a direction orthogonal to a normal vector from the floor, this may not always be the case. Indeed, the depth sensors 115a-d may be positioned at a wide variety of angles, some of which place the fields of depth data capture 120a-d at angles oblique to the floor and/or wall. For example, depth sensor 115c may be positioned near the ceiling and be directed to look down at the user 105 on the floor.

This relation between the depth sensor and the floor may be extreme and dynamic in some situations. For example, in situation 100c a depth sensor 115e is located upon the back of a van 140. The van may be parked before an inclined platform 150 to facilitate loading and unloading. The depth sensor 115e may be used to infer user gestures to direct the operation of the van (e.g., move forward, backward) or to perform other operations (e.g., initiate a phone call). Because the van 140 regularly enters new environments, new obstacles and objects 145a,b may regularly enter the depth sensor's 115e field of depth capture 120e. Additionally, the inclined platform 150 and irregularly elevated terrain may often place the depth sensor 115e, and corresponding field of depth capture 120e, at oblique angles relative to the “floor” on which the user 105 stands. Such variation can complicate assumptions made regarding the depth data in a static and/or controlled environment (e.g., assumptions made regarding the location of the floor).

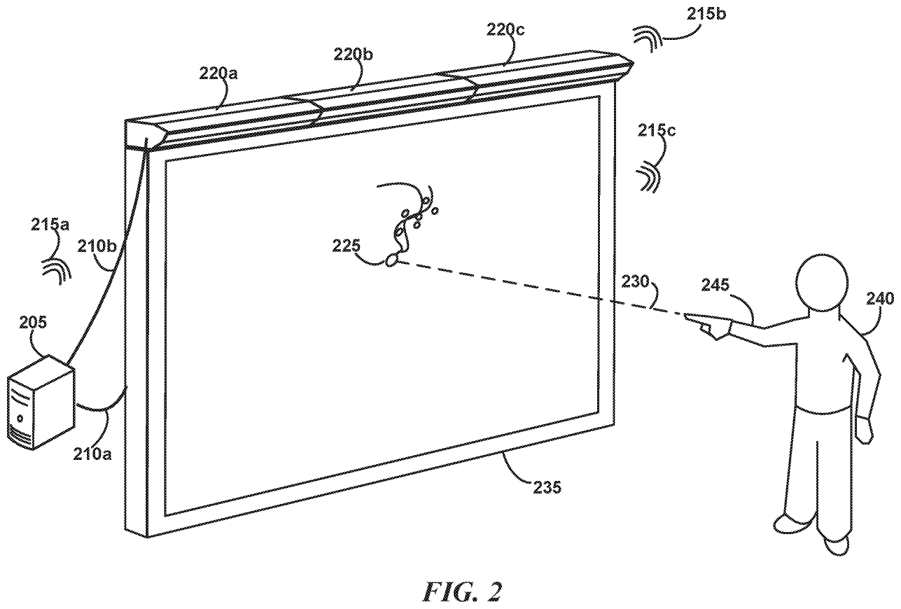

Various embodiments may include a housing frame for one or more of the depth sensors (e.g., as described in U.S. patent application Ser. No. 15/478,209). The housing frame may be specifically designed to anticipate the inputs and behaviors of the users. In some embodiments, the display system may be integrated with the housing frame to form modular units. FIG. 2 is a schematic diagram of an example widescreen display with, e.g., a multi-angled depth sensor housing as may be implemented in some embodiments. For example, the system may include a large, single display 235 with which a user 240 may interact via various spatial, temporal, and spatial-temporal gestures 230 using, e.g., their hands 245, arms or entire body. For example, by pointing with the finger of their hand 245, the user may direct the motion of a cursor 225. The display 235 may be in communication with a computer system 205 via, e.g., a direct line connection 210a, wireless connections 215c and 215a, or any other suitable means for communicating the desired display output. Similarly, the computer system 205 may be in communication with one or more depth sensors contained in housing frames 220a-c via a direct line connection 210b, wireless connections 215b and 215a, or any other suitable means for communicating the desired display output. Though shown separately in this example, in some embodiments, the computer system 205 may be integrated with either the housing frames 220a-c or display 235, or be contained off-site.

Each of housing frames 220a-c may contain one or more depth sensors as described elsewhere herein. The computer system 205 may have transforms available to relate depth data acquired at each sensor to a global system of coordinates relative to display 235. These transforms may be achieved using a calibration process, or may, e.g., be preset with a factory default. Though shown here as separate frames, in some embodiments the frames 220a-c may be a single frame. The frames 220a-c may be affixed to the display 235, to a nearby wall, to a separate mounting platform, etc.

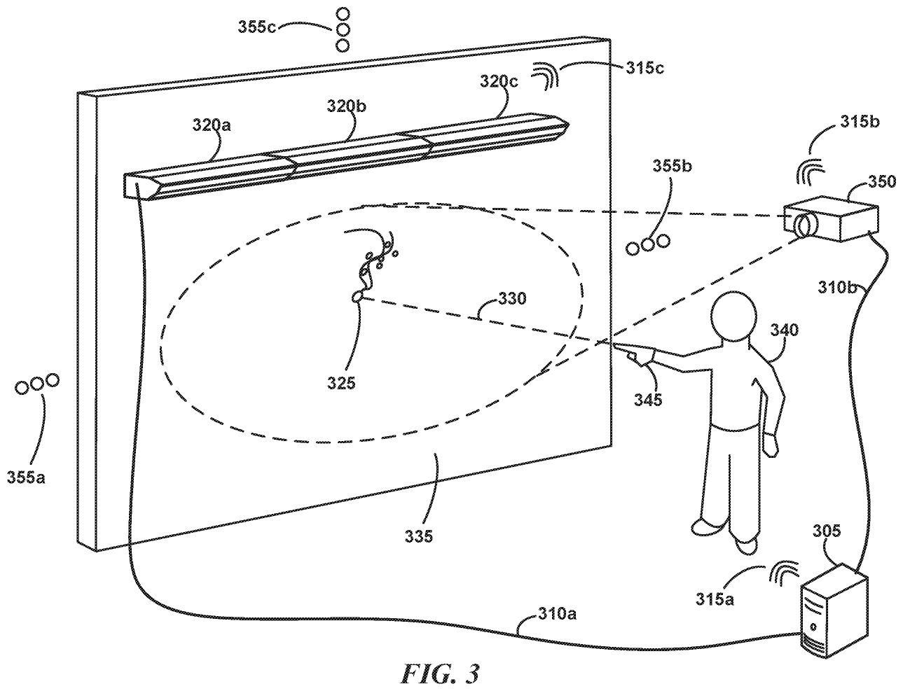

While some embodiments specifically contemplate providing a display system connected with the housing frames, one will readily appreciate that systems may be constructed in alternative fashions to achieve substantially the same function. For example, FIG. 3 is a schematic diagram of an example projected display with a multi-angled depth sensor housing frames 320a-c as may be implemented in some embodiments. Here, the frames 320a-c have been affixed to a wall 335, e.g., a wall in the user's 340 office, home, or shopping environment. A projector 350 (one will appreciate that rear projection from behind the wall 335 may also be used in some embodiments if the wall's 335 material is suitable). As indicated by ellipses 355a-c, the wall 335 may extend well beyond the interaction area in many directions. The projector 350 may be positioned so as to project the desired images upon the wall 335. In this manner, the user may again use their hand 345 to gesture 330 and thereby direct the motion of a cursor 325 (as well as perform other gestures and operations). Similarly, the projector 350 may be in communication with a computer system 305 and the depth sensors in frames 320a-c via direct line connections 310a, 310b, wireless connections 315a-c, or any other suitable communication mechanism.

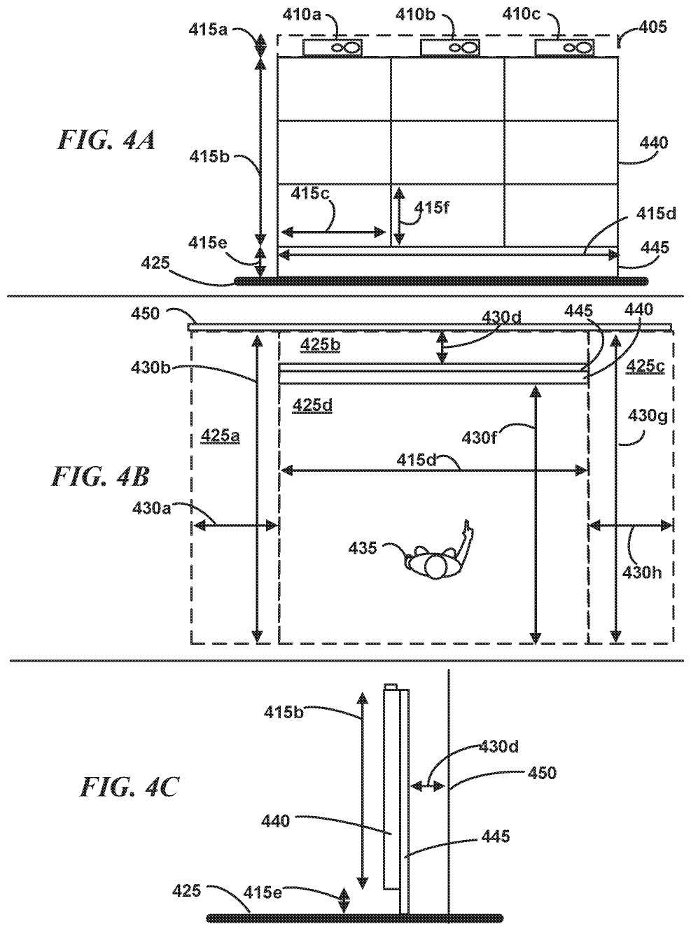

While FIGS. 2 and 3 describe example embodiments with “monolithic” displays, in some embodiments, the displays and frame housing may be designed so to form “modular” units that may be integrated into a whole. For example, FIGS. 4A-C provide greater detail regarding the specific dimensions of a particular example composite display (though one will appreciate that the described dimensions may apply to other examples provided herein). Particularly, FIG. 4A is a head-on schematic view of the composite display with a multi-angled depth sensor housing as may be used in conjunction with some embodiments. In this example the modules are arranged to create a grid of displays 440 together having a composite width 415d of approximately 365 centimeters in some embodiments and height 415b of approximately 205 centimeters in some embodiments. In some embodiments, the depth sensor housing height 415a may be approximately 127 mm. The individual displays may have a width 415c of approximately 122 centimeters in some embodiments and a height 415f of approximately 69 centimeters in some embodiments. In some embodiments, the displays may be HDMI displays with resolutions of 1920×1080 pixels. The displays 440 may be elevated off the ground 425 a distance 415e of approximately 10 centimeters in some embodiments via a support structure 445. Atop the displays 440 may be a depth sensor housing frame or frames 405, here shown transparently to reveal one or more of depth sensors 410a-c.

FIG. 4B is a top-down schematic view of the composite display as may be used in conjunction with some embodiments. FIG. 4C is a side schematic view of the composite display as may be used in conjunction with some embodiments. Note that the depth sensors and housing are no longer shown to facilitate understanding. Within the region 425d the depth sensors may be able to collect depth data. Accordingly, a user 435 would stand within this region when interacting with the system. The region may have a distance 430f of approximately 300 centimeters in some embodiments in front of the display 440 and be approximately the width 415d of the display. In this embodiment, side regions 425a and 425c may be excluded from the interaction. For example, the user may be informed to avoid attempting to interact within these regions, as they comprise less optimal relative angles to depth sensors distributed across the system (in some embodiments, these regions may simply originate too much noise to be reliable). The installing technician may mark or cordon off the areas accordingly. These regions 425a and 425c may include a length 430b, 430g from a wall 450 of approximately 350 centimeters in some embodiments and a distance 430a, 430h from the active region 425d of approximately 100 centimeters in some embodiments. A region 425b may be provided between the support structure 445 and a wall support structure 450 or other barrier, to facilitate room for one or more computing systems. Here, a distance 430d of approximately 40 centimeters in some embodiments may be used and a length 415d reserved for this computing system space. In some embodiments, the support structure 445 may extend throughout the region 425b and the computer system may rest on or within it.

One will appreciate that the example dimensions provided above are merely used in connection with this specific example to help the user appreciate a specific embodiment. Accordingly, the dimensions may readily be varied to achieve substantially the same purpose.

### Example Depth Data

Depth capture sensors may take a variety of forms, including RGB sensors using parallax to infer depth, range-based lidar, infrared pattern emission and detection, etc. Many of these systems may capture individual “frames” of depth data over time (i.e., the depth values acquired in the field of view at a given instant or over a finite period of time). Each “frame” may comprise a collection of three-dimensional values for depths measured in the field of view (though one will readily recognize multiple ways to represent, e.g., a time of flight analysis for depth determination). These three-dimensional values may be represented, e.g., as points in three-dimensional space, as distances for rays emitted at various angles from the depth sensor, etc.

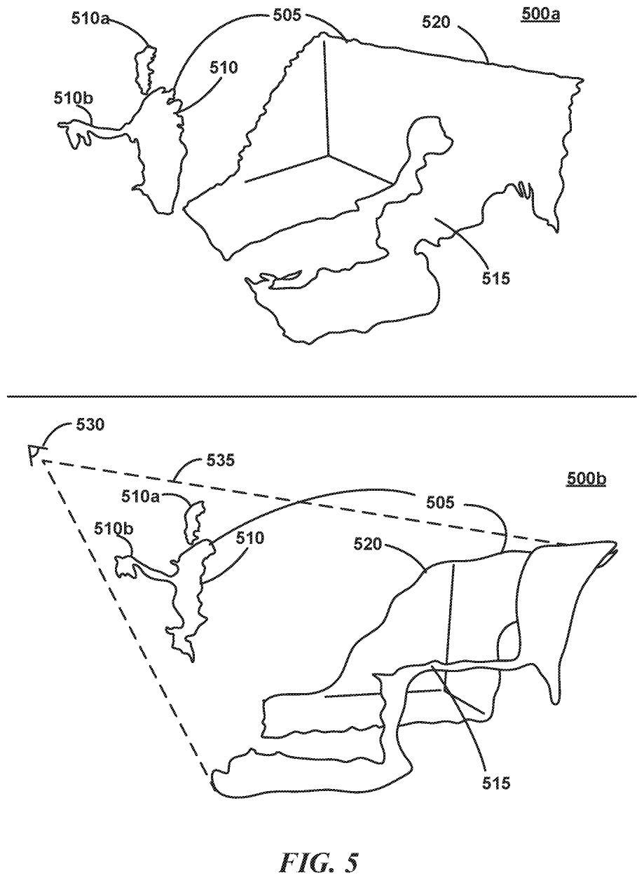

FIG. 5 is a series of perspective 500a and side 500b views of example depth data 505 as may be used in some embodiments. In this example, a user is pointing at the depth sensor with his right hand while standing in front of a wall. A table to his left has also been captured in the field of view. Thus, depth values associated with the user 510 include a portion associated with the user's head 510a and a portion associated with the user's extended right arm 510b. Similarly, the background behind the user is reflected in the depth values 520, including those values 515 associated with the table.

To facilitate understanding, the side view 500b also includes a depiction of a depth sensor's field of view 535 at the time of the frame capture. The depth sensor's angle 530 at the origin is such that the user's upper torso, but not the user's legs have been captured in the frame. Again, this example is merely provided to accommodate the reader's understanding, and the reader will appreciate that some embodiments may capture the entire field of view without omitting any portion of the user. For example, the embodiments depicted in FIGS. 1A-C may capture less than all of the interacting user, while other embodiments may capture the entirety of the interacting user (in some embodiments, everything that is more than 8 cm off the floor appears in the depth field of view). Of course, the reverse may be true depending upon the orientation of the system, depth camera, terrain, etc. Thus, one will appreciate that variations upon the disclosed examples are explicitly contemplated (e.g., classes referencing torso components are discussed below, but some embodiments will also consider classifications of legs, feet, clothing, user pairings, user poses, etc.).

Similarly, though FIG. 5 depicts the depth data as a “point cloud”, one will readily recognize that the data received from a depth sensor may appear in many different forms. For example, a depth sensor, such as depth sensor 115a or 115d, may include a grid-like array of detectors. These detectors may acquire an image of the scene from the perspective of fields of depth captures 120a and 120d respectively. For example, some depth detectors include an “emitter” producing electromagnetic radiation. The travel time from the emitter to an object in the scene and then to one of the grid cell detectors may correspond to the depth value associated with that grid cell. The depth determinations at each of these detectors may be output as a two-dimensional grid of depth values. The resulting “depth frame” in this example would be the two-dimensional grid, though again, one will appreciate that in some systems a “depth frame” may also refer to other representations of the three-dimensional depth data acquired from the depth sensor (e.g., a point cloud, a sonographic image, etc.).

### Example Depth Data Clipping Methodology

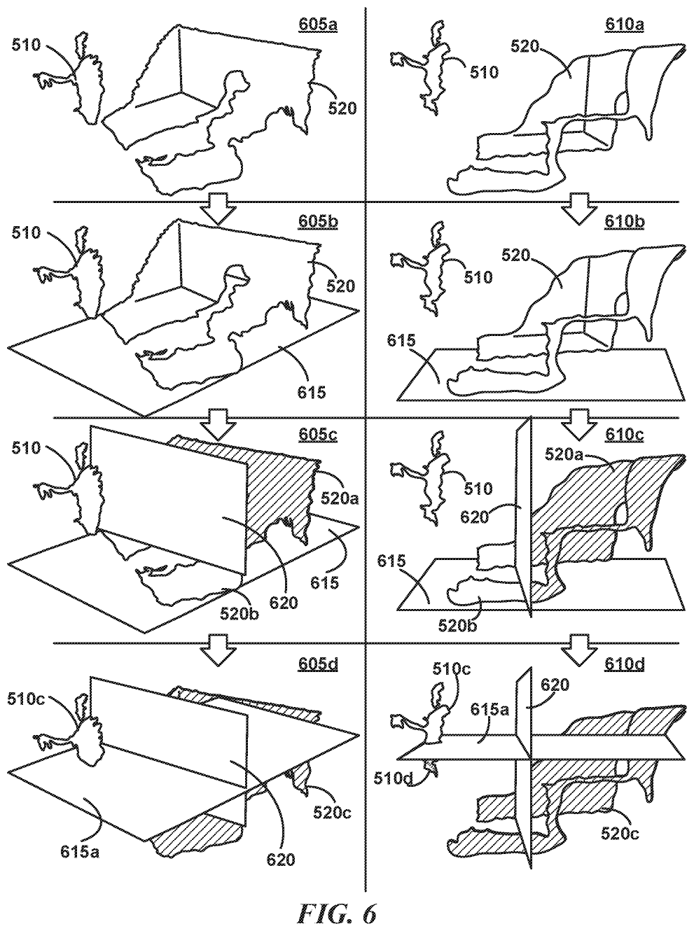

Many applications would like to infer the user's gestures from the depth data 505. Accomplishing this from the raw depth data may be quite challenging and so some embodiments may apply preprocessing procedures to isolate the depth values of interest. For example, FIG. 6 is a series of views illustrating data isolation via plane clipping as may be applied to the depth data 505 of FIG. 5 in some embodiments. Particularly, perspective view 605a and side view 610a illustrate the depth data 505 (including portions associated with the user 510 and portions associated with the background 520). Perspective view 605b and side view 610b show the depth data 505 relative to a floor plane 615. The floor plane 615 is not part of the depth frame data 505. Rather, the floor plane 615 may be assumed based upon context or estimated by the processing system.

Perspective view 605c and side view 610c introduce a wall plane 620, which may also be assumed or estimated by the processing system. The floor and wall plane may be used as “clipping planes” to exclude depth data from subsequent processing. For example, based upon the assumed context in which the depth sensor is used, a processing system may place the wall plane 620 halfway to the maximum range of the depth sensor's field of view. Depth data values behind this plane may be excluded from subsequent processing. For example, the portion 520a of the background depth data may be excluded, but the portion 520b may be retained as shown in perspective view 605c and side view 610c.

Ideally, the portion 520b of the background would also be excluded from subsequent processing, since it does not encompass data related to the user. Some embodiments further exclude depth data by “raising” the floor plane 615 based upon context to a position 615a as shown in perspective view 605d and side view 610d. This may result in the exclusion of the portion 520b from future processing. These clipping operations may also remove portions of the user data 510d which will not contain gestures (e.g., the lower torso). Thus, in this example, only the portion 510c remains for further processing.

As mentioned previously, the reader will appreciate that this example is provided merely to facilitate understanding and that in some embodiments clipping may be omitted entirely, or may occur only very close to the floor so that leg and even foot data are both still captured. One will recognize that FIG. 6 simply depicts one possible clipping process for a given context. Different contexts, for example, situations where gestures include the user's lower torso, may be addressed in a similar fashion. Many such operations may still require an accurate assessment of the floor 615 and wall 620 planes to perform accurate clipping.

### Example Depth Data Classification Methodology

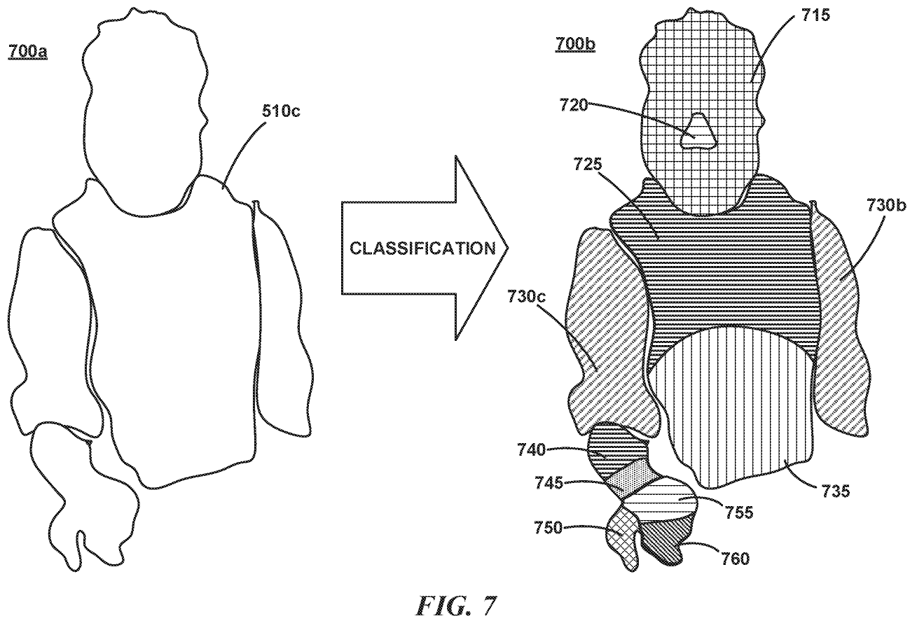

Following the isolation of the depth values (which may not occur in some embodiments), which may contain gesture data of interest, the processing system may classify the depth values into various user portions. These portions, or “classes”, may reflect particular parts of the user's body and can be used to infer gestures. FIG. 7 is an example component classification as may be applied to the isolated data of FIG. 6 in some embodiments. Initially 700a, the extracted data 510c may be unclassified. Following classification 700b, each of the depth values may be associated with a given classification. The granularity of the classification may reflect the character of the gestures of interest. For example, some applications may be interested in the direction the user is looking, and so may break the head into a “head” class 715 and a “nose” class 720. Based upon the relative orientation of the “head” class 715 and the “nose” class 720 the system can infer the direction in which the user's head is turned. Since the chest and torso are not generally relevant to the gestures of interest in this example, only broad classifications “upper torso” 725 and “lower torso” 735 are used. Similarly, the details of the upper arm are not as relevant as other portions and so a single class “right arm” 730c and a single class “left arm” 730b may be used.

In contrast, the lower arm and hand may be very relevant to gesture determination and more granular classifications may be used. For example, a “right lower arm” class 740, a “right wrist” class 745, a “right hand” class 755, a “right thumb” class 750, and a “right fingers” class 760 may be used. Though not shown, complementary classes for the left lower arm may also be used. With these granular classifications, the system may able to infer, e.g., a direction the user is pointing, by comparing the relative orientation of the classified depth points.

One will appreciate that “gestures” may be static (e.g., pointing a finger) or dynamic (e.g. swiping an arm). Consequently, some gestures may be recognized in a single frame, while some may require a collection of frames to be recognized. Classification may help facilitate recognition by showing the temporal and spatial relations to classes of pixels over time.

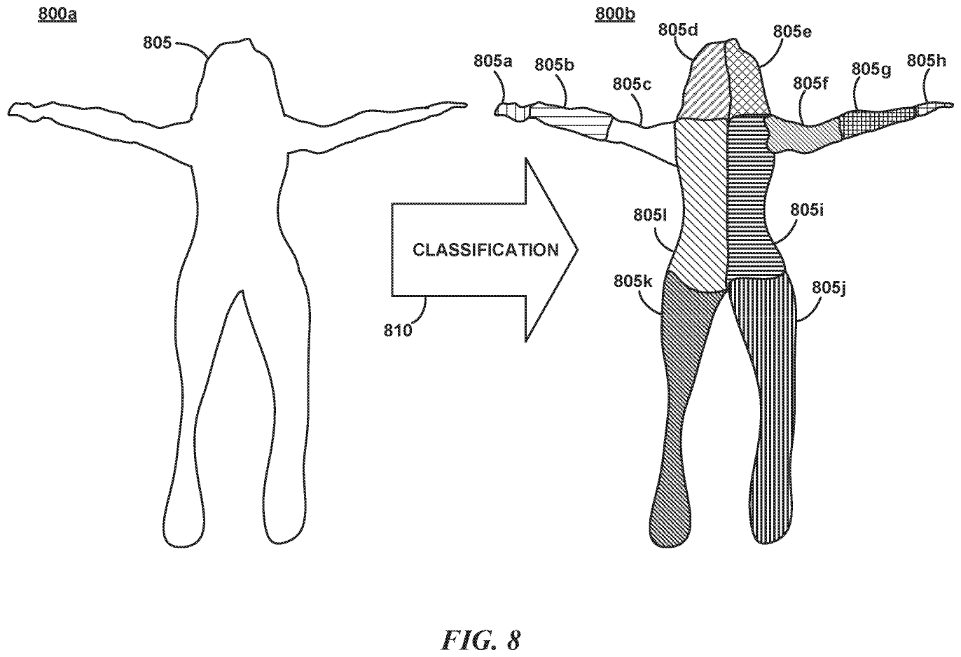

FIG. 8 is another example full-body depth-value classification as may be applied to captured depth data in some embodiments. In some embodiments, more general body classifications may suffice to identify hand, arm, or leg-based gestures. For example, FIG. 8 is a schematic representation of a computer system's classification 810 of a plurality of depth values 805 associated with a user standing with outstretched arms before the depth camera into one of twelve categories 805a-j. Particularly, left 805j and right 805k leg classifications, left 805i and right 805l torso classifications, and left 805e and right 805d head classifications, may facilitate a determination of the user's orientation relative to the interface. To facilitate recognition of arm and hand gestures, the user's arms may be more granularly classified. For example, with right 805c and left 805f upper arm, right 805b and left 805g lower arm, and right 805a and left 805h hand classes. While there is no explicit shoulder class in this example, one will appreciate that a shoulder boundary point may be identified in some embodiments by averaging depth values along the boundaries of, e.g., a right shoulder point using depth values in classes 805c and 805l. Accordingly, one will appreciate variations on the disclosed examples (e.g., where a shoulder class has been explicitly identified).

One will appreciate that between receipt of the initial depth values 800a and creation of the classified result 800b, minimal or no clipping may have been performed, e.g., as described above with respect to FIG. 6 (e.g., the clipping operation may be absent from the Pre-processing module 915 described below).

### Example Processing Pipeline

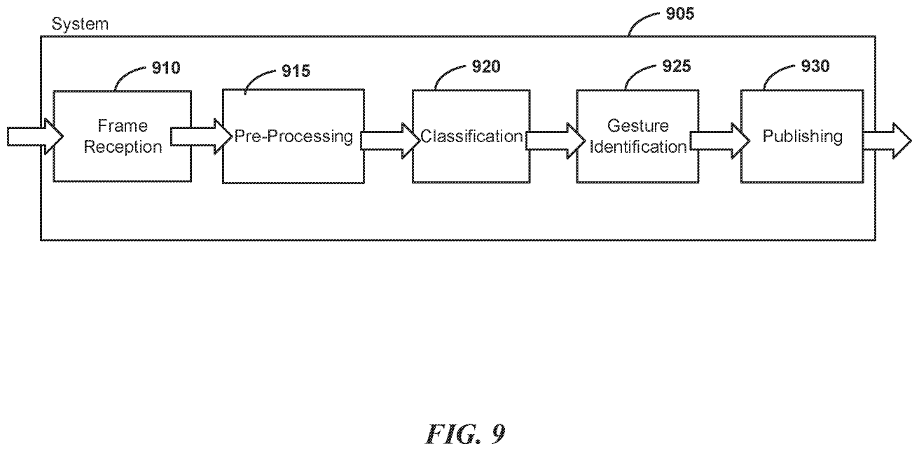

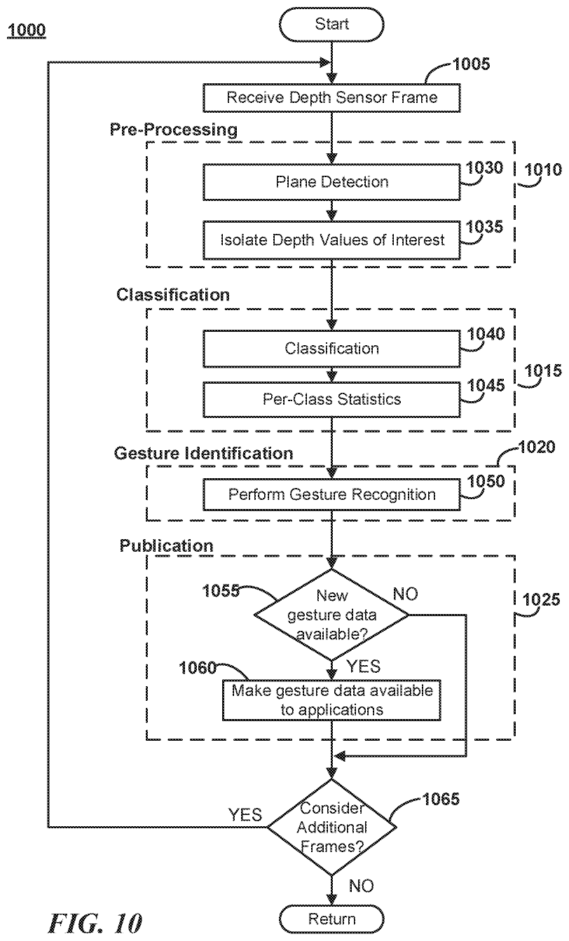

FIG. 9 is a block diagram illustrating an example modular software/firmware/hardware implementation 905 which may be used to perform depth data processing operations in some embodiments. A frame reception system 910 may receive a depth frame from a depth sensor. The frame reception system 910 may be firmware, software, or hardware (e.g., an FPGA implementation, system-on-a-chip, etc.). The frame may be directly passed, or stored and subsequently passed, to a pre-processing module 915. Pre-processing module 915 may also be firmware, software, or hardware (e.g., an FPGA implementation, system-on-a-chip, etc.). The pre-processing module may perform the Preprocessing operations 1010 discussed in FIG. 10. The pre-processing results (e.g., the isolated depth values 510c) may then be provided to the Classification module 920. The Classification module 920 may be firmware, software, or hardware (e.g., an FPGA implementation, system-on-a-chip, etc.). The Classification module 920 may perform the Classification operations 1015 discussed in FIG. 10. The classified depth values may then be provided to a Gesture Identification module 925, which, again, may be software, firmware or hardware. The Gesture Identification module 925 may recognize gestures in the data, e.g., alone or by comparison to previously received data, using various of the embodiments disclosed herein. The Gesture Identification module 925 may then provide the gesture results to the Publishing module 930, which may be configured to package the classification results into a form suitable for a variety of different applications (e.g., as specified at 1020 by providing the LEFT, RIGHT, UP, or DOWN direction of a user's swipe gesture). For example, an interface specification may be provided for kiosk operating systems, gaming operating systems, etc. to receive the classified depth values and to infer various gestures therefrom. Thus, in some embodiments, Publishing module 930 may simply provide an Application Programming Interface (API) for these applications to receive the identified gesture data.

FIG. 10 is a flow diagram illustrating some example depth data processing operations 1000 as may be performed in some embodiments. At block 1005, the processing computer system may receive a frame of depth sensor data (e.g., a frame such as frame 505 discussed above). Generally speaking, the data may then pass through “Pre-Processing” 1010, “Classification” 1015, “Gesture Identification” 1020, and “Publication” 1025 stages. During “Pre-Processing” 1010, the processing system may perform “plane detection” at block 1030 using the frame data or based upon assumptions or depth camera configuration details (though again, in many embodiments preprocessing and plane detection may not be applied). This may include, e.g., the clipping planes discussed with respect to FIG. 6, such as the floor 615 plane and wall plane 620. These planes may be used, e.g., to isolate the depth values of interest at block 1035, e.g., as described above with respect to FIG. 6.

During Classification 1015, the system may associate groups of depth values with one class (or in some embodiments, multiple classes) at block 1040. For example, the system may determine a classification using classes as discussed with respect to FIG. 7. At block 1045, the system may determine per-class statistics (e.g., the number of depth values associated with each class, the effect upon ongoing system training and calibration, etc.). Example classes may include: Nose, Left Index Finger, Left Other Fingers, Left Palm, Left Wrist, Left Shoulder, Right Shoulder, Right Index Finger, Right Other Fingers, Right Palm, Right Wrist, and Other.

During the Gesture Identification 1020 operations the system may perform gesture recognition at block 1050, using methods described below. During Publication 1025, at block 1055 the system may determine if new gesture data is available. For example, a new swipe gesture from right to left may have been detected at block 1050. If such a new gesture is present, the system may make the gesture data available to various applications, e.g., a kiosk operating system, a game console operating system, etc., at block 1060. At block 1065, the operations may be performed again for additional frames received.

Again, one will recognize that the process may be used to infer gestures across frames by comparing, e.g., the displacement of classes between frames (as, e.g., when the user moves their hand from left to right). Similarly, one will appreciate that not all the steps of this example pipeline (e.g., preprocessing 1010 or classification 1015) need be performed in every embodiment.

### Heuristics Overview

Ideally, interactions with the human-computer interface should be intuitive for the user. Accordingly, the system may readily recognize gestures and actions, such as: swipes (substantially linear hand motion in a direction, e.g., up, down, left, or right); pointing at the screen; rotation of the user's body; etc. In many instances, the most complicated gesture for the system to identify is the swipe gesture, particularly, to determine whether the user intended to swipe in one of four general directions (e.g., UP, DOWN, LEFT, and RIGHT). Naively tracing the hand classified depth values over a succession of frames may encounter a variety of problems. For example, users may need to move their hand into position before a swipe and to move their hand back to a rest position after a swipe. These movements do not convey the user's intent and may travel in directions other than the direction associated with the swipe gesture itself.

In addition, users often do not swipe in an exactly straight line, but instead move their hand in a curve. When combined with the motion to move their hands into position and back to rest, the complete hand motion may form a large arc, very little of which may be in the same direction the user intends the system to recognize. In addition to this natural deviation, the swipe gesture is often performed differently by different individuals. Some users may stretch out their arms during their gesture while others may keep their arms closer to their bodies. Similarly, some users swipe faster than others and some users perform all their gestures with the same hand, while other users may switch hands. These variations may cause the hand motion to vary dramatically from person to person. Indeed, even the same person may swipe differently over the course of a session.

To be able to interpret ambiguous gestures, some embodiments consider implementing various heuristics as part of the recognition process. Example heuristics include: consideration of a gesture zone; in-zone transitions; gesture angle boundaries, and dynamic versus static hand identification. These heuristics may be used, e.g., to hand-craft recognition solutions to different contexts and as the basis for features in machine learning. For example, training data may be used to learn these heuristics with a Support Vector Machine (SVM), neural network, or other learning system. As compared to other methods, the heuristics may reduce the amount of training data needed for accurate recognition.

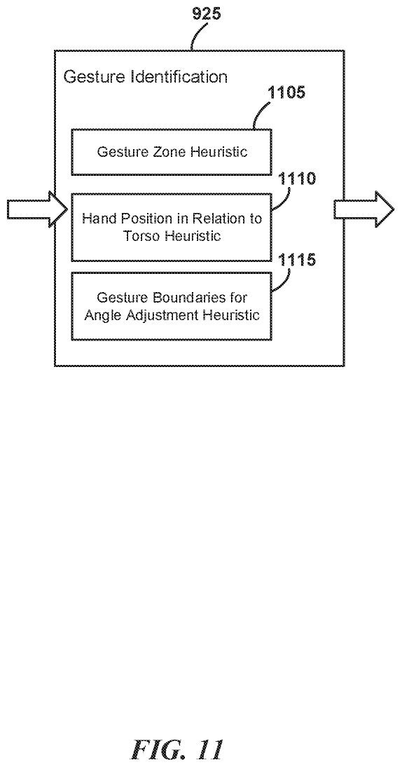

FIG. 11 is a schematic block diagram illustrating three heuristic factors facilitating improved swipe gesture recognition within the gesture recognition block 925 of FIG. 9, in some embodiments. Particularly, some embodiments augment block 925 to consider one or more of a gesture zone heuristic 1105, a hand position relative to the user's torso heuristic 1110, and a gesture boundaries for angle adjustment heuristic 1115, when a determining gestures, particularly swipe gestures. These heuristics and examples of their application are provided in greater detail below.

### Example Conceptual Modelling for Gesture Detection—Heuristics—Gesture Zone

A “gesture zone” is a region of space before the user, which may be used by the system to inform depth value assessment. For example, the position of the user's hand relative to the gesture zone dimensions may be used to indicate a phase of the gesture (e.g., the “Action” phase described below).

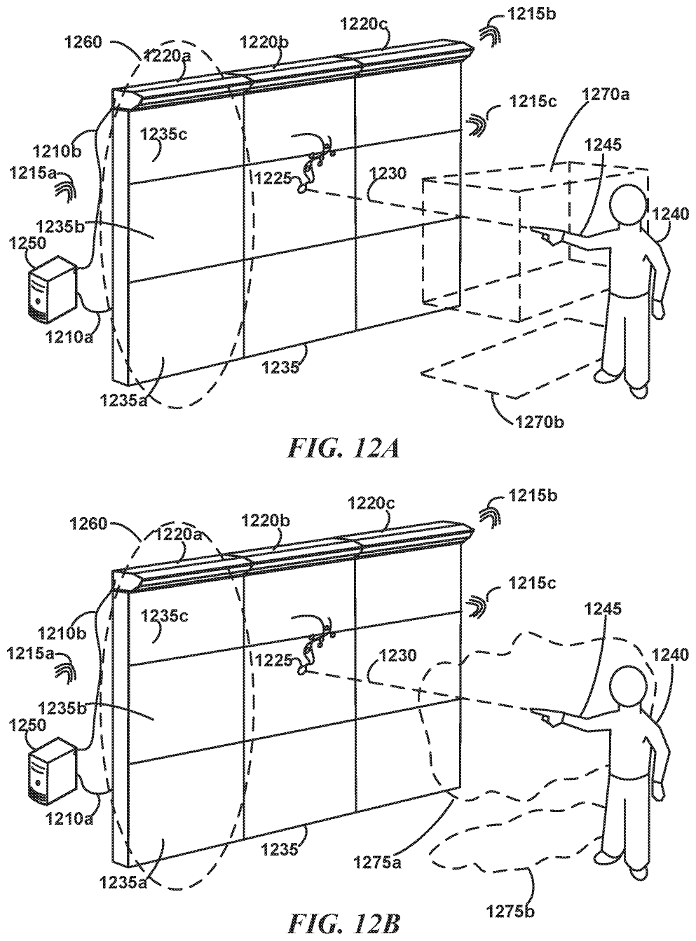

FIG. 12A is a schematic diagram of an example composite display 1235 (e.g., each element comprising a vertical section 1260 having multiple displays 1235a-c) with a collection of multi-angled depth sensor housing frames 1220a-c as may be used in conjunction with some embodiments. Though a composite display is used here to facilitate explanation, one will appreciate that any of the machine vision systems referenced herein may be used in conjunction with a gesture box (also referred to as a “gesture zone” herein). Here, the user 1240 may use hand 1245 gestures 1230 to interact with displayed items, e.g., cursor 1225. A computer system 1250 (here shown on-site and separate from the other components) may be in communication with the depth sensors and display via direct line connections 1210a, 1210b, wireless communications 1215a-c, or any other suitable communications method. One will appreciate that in some embodiments each module will have its own computer system, while, as shown here, in some embodiments there may be a single computer system associated with several or all of the modules. The computer system(s) may process depth data and provide images to the displays on their respective module(s).

Computer system 1250 may anticipate the use of a “gesture box” 1270a before the user 1240. The gesture box 1270a may be raised above the floor (thus corresponding to a projection 1270b upon the floor). The gesture box 1270a may not be a physical object, visible to the user, but may instead reflect a region between the user and the display anticipated by computer processing system 1250 to facilitate gesture recognition as described herein. For example, motions by the user 1240, which place the user's hand 1245 within the box 1270a may receive different scrutiny by system 1250 as compared to motions outside the box. Use of gesture box 1270a may not only isolate gesture-related motions for processing, but may also provide a metric for identifying a given gesture.

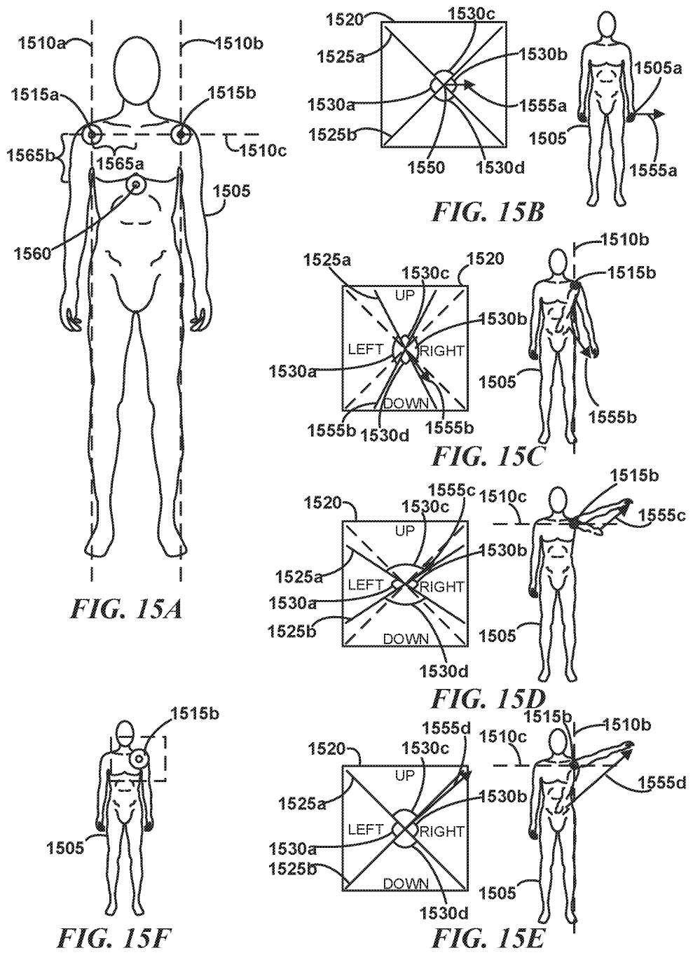

Note that while the region associated with “gesture box” 1270a is shown as an actual box in FIG. 12A, this need not be the case (consequently, the terms “gesture zone” and “gesture box” are used interchangeably herein). FIG. 12B is a schematic diagram of the example composite display of FIG. 12A, but with an arbitrary-shaped gesture box 1275a (and corresponding floor projection 1275b), as may be implemented in some embodiments. Such an amorphous gesture region may occur, e.g., when the computer system 1250 adjusts a box over time based upon previous usage and behaviors. Thus, the box need not be a “box” shape in every embodiments, but may be a trapezoidal region, a convex hull over a cloud of points before the user, a sphere, an spheroid, etc. Similarly, the gesture zone may not be centered in front of the user, but my be offset relative to, e.g., the user's shoulder, e.g., as will be discussed in relation to FIG. 15F.

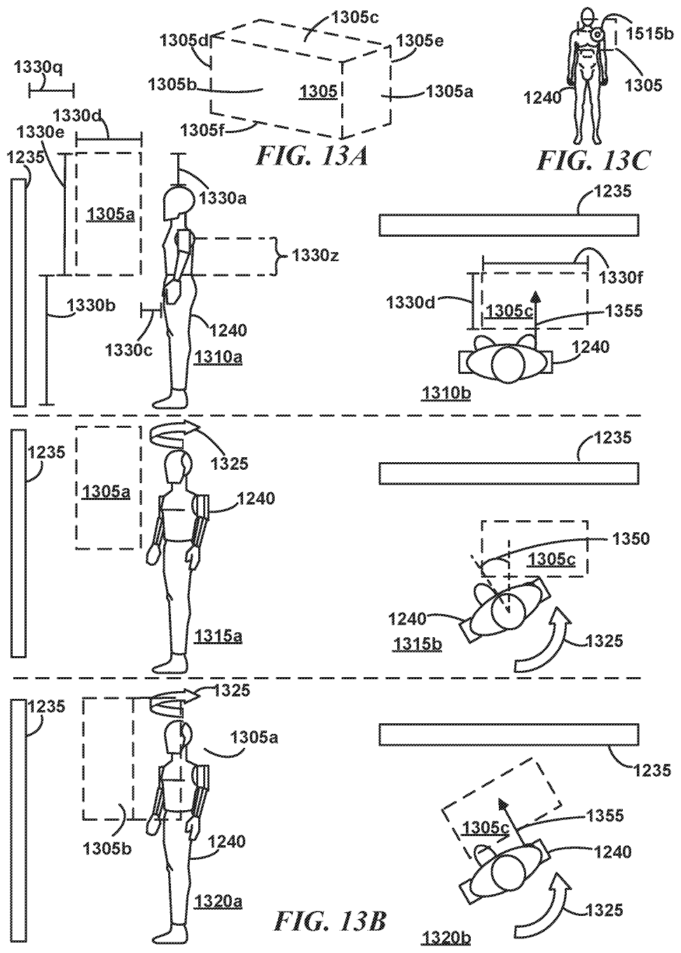

FIG. 13A is a schematic representation of an example gesture box 1305. Again, as discussed above, the box need not be a literal “box” in each embodiment, but will be depicted as such here to facilitate an explanation of one example set of dimensions. Accordingly, the dimensions discussed here may serve as the outer dimensions for a zone of different placement and shape.

The box may have a front face 1305b, a left face 1305a, and a top face 1305c. Not visible in the diagram are a right face 1305d, bottom face 1305f and back face 1305e. The naming convention used here (“front,” “back,” etc.) is arbitrary and chosen to facilitate understanding. As will be discussed with reference to FIG. 13B, back face 1305e is typically closest to the user, while front face 1305b is typically closer to the display.

FIG. 13B is a series of side 1310a and top-down 1310b schematic views of a user interacting with an interface using the gesture box of FIG. 13A, as may occur in various embodiments. Particularly, in side-view 1310a, the user 1240 is directly facing the display 1235. From this view the “left side” 1305a of the gesture box 1305 is visible to the reader. The gesture box 1305 may extend a length 1330a above the user's 1240 head (again, as mentioned elsewhere herein, this distance may be unconstrained in some embodiments).

The gesture box 1305 may be a distance 1330c before the user 1240. The gesture box 1305 may be a distance 1330q from the display 1235. The gesture box 1305 may be a distance 1330b from the floor. In some embodiments, placement of the box may depend upon the classification of depth values associated, e.g., with the user's torso. For example, the center position of the box may be placed at an offset towards the display from the center position of the depth values classified as “torso” (though, again, some embodiments may instead center the box at either the user's left or right shoulder-classified values as shown in FIG. 15F). In some embodiments, the gesture box position and dimensions are universal to different users. In some embodiments, however, the box's dimensions and position may be adjusted once the user's head and torso are classified (e.g., children may be associated with a smaller box closer to the ground as compared to an adult user).

In some embodiments, the gesture zone is centered at the user's left 1515b or the right 1515a shoulder joint or point, for identifying gesture by the left or right hand respectively. This may be the user's physical joint location in some embodiments, but may instead be an approximation to the position of the joint from the depth values in some embodiments. The gesture zone's depth 1330d may be 20 cm from the user's torso when the gesture box abuts the torso (i.e., where the distance 1330c is zero and not some positive value as shown in the figure to facilitate understanding). Note that hand positions closer to the user's torso may be less likely to associated with the user's intentions, as discussed below, and distance 1330c may be increased accordingly. There may be no bound on how far the hand can be from the user's torso in some embodiments (e.g., distance 1330q may be zero). In some embodiments, the width 1330f of the gesture zone may be 120 cm, centered at the left 1515b (or right 1515a) shoulder point. Accordingly, there may be 60 cm on either side of the point.

In some embodiments, the gesture zone's lower boundary may be 35 cm below the shoulder point (e.g., the distance 1330z) but with no bound on how high the hand can be (i.e. the height 1330e may be unconstrained, rather than finite, as shown). In some embodiments, the size and position of the gesture zone may adapt to the physical dimensions of the user. For example, a taller person may have a larger gesture zone compared to a shorter person. Since the taller person would have a shoulder joint higher above the ground, the taller person would also have a gesture zone positioned higher above the ground.

In some embodiments, rather than vary the gesture zone size using the height of the person, the system may measure the length of the person's arm following classification. This length may provide a more precise method for determining the size of the gesture zone. For gestures that involve two hands, the gesture zone may be a union of the two individual gesture zones, for each of the left and right hands, as described above.

In some embodiments, the position of the gesture box may depend upon the user's orientation, while in some embodiments the box may remain fixed regardless of the user's orientation. For example, in views 1315a and 1315b the user 1240 has rotated 1325 their torso (rotating the shoulder classified depth values accordingly) to the left. However, in this example embodiment, the position and orientation of the box remains fixed. In contrast, in the embodiment illustrated with views 1320a and 1320b the box has “tracked” the user's torso movement to remain in a position roughly parallel with the lateral dimension of the user's torso. Rotation of the user's torso in this manner may precipitate a new angle 1350 between the centerline of the user's torso and the shortest distance to the display 1235. When the box does not track the user's movement, as in view 1315b, in some embodiments, the system may adjust the recognition process (e.g., via a transform) to recognize gestures in the user's new orientation. Similarly, even when the box does track the user's torso rotation, the system may appreciate that a movement relative to the user's centerline is no longer relative to the centerline of the display in the same manner.

In some embodiments, the computer system may adjust the box's position based upon torso movements exclusively (e.g., as here, where the user's feet remain stationary at their original position). Similarly, in some embodiments, the box may follow the user's torso when the user crouches, jumps, or otherwise changes elevation. In some embodiments, the user's head, alone or in conjunction with the user's torso, may instead be used to position the box.

As mentioned, while the gesture zone may be centered about the center of the user's torso in some embodiments, in this example, the zone is centered around the centroid of the shoulder-classified values (or the shoulder point at a boundary of values determined as discussed herein, etc.). Accordingly, the zone's center may track an arrow 1355 extending from the user at this centroid in the embodiments illustrated with views 1320a and 1320b (similarly, for a torso centroid oriented zone, the arrow would extend from the center of the user's torso and be similarly tracked by the zone). The origin of arrow 1355 may serve as the origin for a corresponding coordinate system (e.g., positions along the arrow from the of the user reflecting increasingly positive coordinate positions in the Z-direction). Thus, the coordinate system may translate and not rotate as shown in the example of 1315b or may both translate and rotate as shown in the example of 1320b. Though the user's right shoulder is used in this example, one will appreciate that the zone may be located at the left shoulder for a left-based hand gesture.

### Example Conceptual Modelling for Gesture Detection

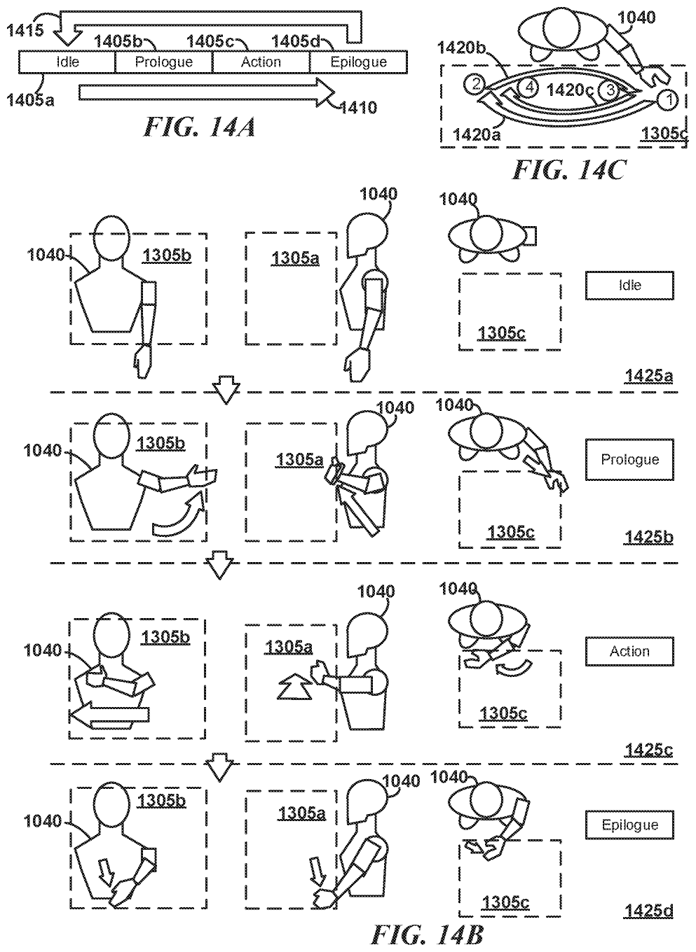

FIG. 14A is a schematic diagram illustrating an example gesture breakdown into “Idle” 1405a, “Prologue” 1405b, “Action” 1405c, and “Epilogue” 1405d phases as may be used in some embodiments. Each of these phases may informally represent a “state” in a state machine modelling the progress of a user's performance of a gesture (one will appreciate that the states may overlap, e.g., the prologue and action, as discussed below). For example, in some embodiments, when the hand is outside the gesture zone, the system may consider the state to be the Idle phase. Conversely, if the hand is inside the gesture zone, the system may record the gesture state as being one of the prologue, action or epilogue phases. Associating hand motions with these phase classifications may better ascertain the user's intentions as compared to analyzing their hand movements alone.

To facilitate understanding, FIG. 14B is a schematic diagram illustrating a series of user gesture motions during each of the phases in FIG. 14A relative to a gesture box in an example “swipe” gesture, as may occur in some embodiments.

Prior to performing a gesture, a user may begin in an idle state 1405a, where the user may not be performing any actions. This state may occur, e.g., when the user's arms are resting by their side in a rest position as shown in the various views at time 1425a. As time progresses 1410 during the gesture's performance, the user may enter a prologue state 1405b at time 1425b. The prologue may reflect a preliminary motion by the user in preparation for a gesture, e.g., the user moving their hand into position for a horizontal “swipe” gesture motion as shown in the various views at time 1425b. In some embodiments, the prologue may include a motion leading to entry into the gesture box.

In the subsequent action state 1405c, the user may perform the actual gestural motions intended to convey the user's intent to the system. Here, for example, the user is “swiping” their hand from left to right at time 1425c. The epilogue 1405d state then includes any user motions after the user has provided sufficient information for the system to identify the intended gesture. Thus, the epilogue may reflect the remainder of the gesture not associated with the user's intention, such as motion of the user's hand back to the rest position as shown at time 1425d. Once the user's hand exits the gesture zone, the system may return 1415 the gesture state to idle 1405a. The process may then begin again with the same or different gesture.

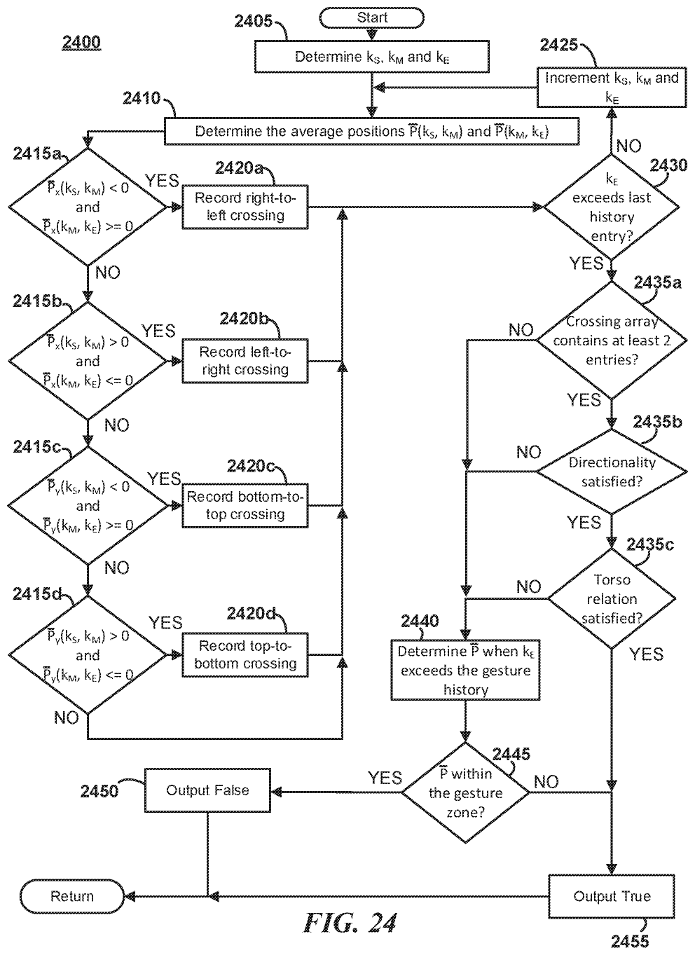

As discussed in greater detail herein, in some embodiments the user may transition from one gesture into a new gesture. For example, the user's hand may remain in the gesture zone between the end of one gesture and the start of the next gesture. This scenario is discussed in greater detail herein with respect to FIG. 24.

Identifying the beginning and end of the action phase may be important to properly recognizing a gesture. Unfortunately, the system may not know the exact points when the action phase begins and ends. Instead, the system may try to identify the start of the prologue and then repeatedly attempt to identify motions associated with intent, i.e., those in the action or prologue phases.

### Example Conceptual Modelling for Gesture Detection—Heuristics—In-Zone Transitions

In some gestures, the user may transition from one gesture to another without bringing their hand to a complete standstill. By considering the distance of the user's hand from the user's torso, motions associated with the user's intentions may be distinguished from other motions unrelated to those intentions. For example, FIG. 14C is a schematic diagram illustrating successive user gesture sets relative to a gesture box, as may occur in some embodiments. Here, the user has made a first left-to-right swipe 1420a from position “1” to position “2,” then a right-to-left motion 1420b, from position “2” to position “3”, before completing a final left-to-right swipe 1420c from position “3” to “4,” all of which occur within the gesture box. As discussed elsewhere herein, the system may distinguish swipes (e.g., 1420a, 1420c) from non-swipe actions (e.g., 1420b) based on the distance from the user's hand to their torso.

Accordingly, in some embodiments, the system may consider hand movements further away from the user's body as conveying intent, while the system may infer that hand movements closer to the user's body are due to repositioning, e.g., in the prologue or epilogue phases. Stated differently, in this example, the system may construe the hand movements 1420a and 1420c as the action phases of two individual gestures separated by a repositioning hand movement 1420b. This may be accomplished in this example, at least in part, when the system finds that the hand in movement 1420b crosses the vertical boundary 1510b (described in greater detail below) at a shorter distance from the user's torso than the movements 1420a and 1420c. The system may then infer that the first half of 1420b is an epilogue after the action-related movement 1420a, and the second half of 1420b is a prologue prior to the action-related movement 1420c.

### Example Conceptual Modelling for Gesture Detection—Heuristics—Boundary Crossings

Some embodiments distinguish movements associated with gestures by determining whether depth values (or their “pixel” projection on a two-dimensional surface) of certain classes crossed various boundary planes during the user motion. This heuristic may be especially useful for distinguishing prologue, action and epilogue phases of a gesture. For example, when detecting swipe gestures, the system may seek to determine a swipe angle in the range of [−π, +π] representing the direction of the swipe. In natural gestures, this angle can vary widely between users and even with the same user. The system may be biased to infer that horizontal swipes are more likely to cross vertical plane boundaries centered at the user's shoulders, while vertical swipes are more likely to cross a horizontal plane boundary at the user's shoulder.

FIG. 15A is a schematic diagram illustrating example boundary-crossings as may be used for detecting swipe gestures in some embodiments. For example, a vertical right shoulder plane 1510a may pass through the user's 1505 right shoulder 1515a (a centroid of shoulder-classified values, boundary between classes, etc.). Note that in some embodiments there may be an explicit class for shoulder values. However, in some embodiments the “right shoulder” is determined as the center of the boundary between “right upper arm” and “torso” classified depth values (e.g., the point which is an average of points along the boundary between right shoulder classification 805c and right torso classification 8051.

In some embodiments, the left and right shoulder point positions may simply be determined as being 18 cm above the torso centroid position and 10 cm to the left or right of that position. These offsets may be based on a person that is 165 cm tall and adapted to individuals of different heights. In still other embodiments, a left or right shoulder classifier may be used, to identify depth data corresponding to the shoulder point.

Thus, the point 1515a may be taken as the centroid of shoulder classified values, as the centroid of “right upper arm” and “torso” classified values along their boundary, etc. A centroid for the torso-classified values may be determined as the point 1560. As an example set of dimensions, the horizontal distance 1565a between the torso centroid point 1560 and a shoulder point, e.g., point 1515a, may be 10 cm. A vertical distance 1565b distance between the torso centroid point 1560 and a shoulder point, e.g., point 1515a, may be 18 cm.

For detecting left handed swipe gestures, a vertical left shoulder plane 1510b passing through the user's 1505 left shoulder 1515b may be considered. A horizontal plane 1510c may then pass through each of the user's shoulder points and be parallel with the floor. If the user swipes with the left hand, then the vertical plane 1510b is used and whether the hand crosses boundary 1510a may be irrelevant. Conversely, if the user swipes with the right hand, then the vertical plane 1510a is used and whether the hand crosses 1510b may be irrelevant. In some embodiments, when the user swipes with both hands simultaneously, only the left hand may continue to be assessed with reference to boundary 1510b and the right hand may only be assessed with respect to boundary 1510a. However, in embodiments permitting diagonal swipes, the event of crossing both boundaries 1510a and 1510c for the user's right hand or both boundaries 1510b and 1510c for the user's left hand may precipitate angle adjustments so as to favor diagonal swipe directions instead of non-diagonal swipe directions.

FIG. 15B is a schematic diagram illustrating an example angle-division for gesture recognition, as may be used in some embodiments. Particularly, the system may consider UP, LEFT, RIGHT, and DOWN divisions 1520 associated with each of the four possible swipe directions. Though only four directions are considered in this example, one will appreciate that in some embodiments more or less than four directions may be considered (e.g., regions associated with diagonal swipes).

Each region may be associated with an angle between the region's boundaries with neighboring regions. For example, where the regions are divided by boundaries 1525a and 1525b, the LEFT region may be associated with the angle 1530a, the RIGHT region may be associated with the angle 1530b (right and left being here taken from the depth sensor's field of view), the TOP region may be associated with the angle 1530c, and the DOWN region may be associated with the angle 1530d. In some embodiments, each of angles 1530a-d may be set to an initial, default value of π/2 radians. In some embodiments, the center 1550 of the regions of division 1520 may be placed over the position at which a user's hand begins the action phase of the gesture. For example, if the user 1505 moves their left hand 1505a a distance from a start position to an end position represented by vector 1555a, the regions of division 1520 may be considered with the vector 1555a (representing a change in position or change in velocity as described herein) at its center 1550. One will appreciate that the vector may be considered in its original 3-dimensional form (and the boundaries considered to be planes) or in corresponding 2-dimensional projections (and the boundaries considered as lines). The two-dimensional version of the vector may be found by projecting the vector upon a plane parallel with the front face of the user (e.g., parallel with plane 1305b of the gesture box 1305), a plane parallel with the display, etc.

FIG. 15C is a schematic diagram illustrating example angle adjustments to the angle division of FIG. 15B following a vertical boundary crossing, as may be used in some embodiments. Again, for clarity, note that the center of the regions of division 1520 are shown offset relative to the starting position of the user's 1505 hand. In this situation, the user's hand crossed the vertical boundary 1510b, but not the horizontal boundary 1510c during the swipe gesture. The system may infer from this that the gesture is likely a horizontal swipe.

As shown in FIG. 15C, the range of angles associated with left and right swipe directions (angles 1530a and 1530b respectively) may consequently be increased, while the angles that are associated with the up and down swipe directions may be decreased (angles 1530c and 1530d respectively). For example, in some embodiments, the angles 1530a and 1530b may be increased by π/8 radians at both ends of the angle, leading to a total increment of π/4 radians (i.e., the angle 1530a is now 3π/4).

In some embodiments, the system may multiply this angle by a confidence measure that the swipe is horizontal. For example, the measure may be the distance the hand traveled before and after crossing the vertical boundary 1510b. If the hand traveled from 10 cm on one side of the boundary 1510b to 10 cm on the other side of the boundary, that may produce a confidence measure 1. This measure value may result in an angle increase by π/8 radians at each end as previously described.

If instead the hand traveled from 40 cm on one side of the boundary to 40 cm on the other side of the boundary, this longer distance may indicate a more deliberate gesture and increase the confidence measure to 2. Correspondingly, the angle may be increased by 2*π/4. Such an increase may make it very likely the system will classify the gesture as either left or right swipe, rather than an up or down swipe.

Thus, motions of the hand-classified depth pixels at an angle that might previously, e.g., be classified as an “UP” swipe, would now be classified as a “LEFT” or “RIGHT” swipe. For example, if the path of the user's left hand 1505a over several frames during the action phase corresponds to the arrow 1555b, consequently crossing the boundary plane 1510b (but not boundary plane 1510c), then the gesture would be classified as a RIGHT swipe, even though the motion would be a DOWN swipe in the default regions of division 1520 of FIG. 15B.

Conversely, FIG. 15D is a schematic diagram illustrating example angle adjustments to the angle division of FIG. 15B following a horizontal boundary crossing, as may be used in some embodiments. Here, the path of the user's left hand 1505a over several frames during the action phase corresponds to the arrow 1555c, which crosses the boundary plane 1510c (but not boundary planes 1510a or 1510b). When the system adjusts the angles in the regions of division 1505 based upon the exclusive crossing of boundary plane 1510c, the arrow 1555c is now classified as an UP swipe, even though it would be classified as a RIGHT swipe in the default regions of division 1520 of FIG. 15B.

FIG. 15E is a schematic diagram illustrating example angle adjustments to the angle division of FIG. 15B following a vertical boundary crossing and a horizontal boundary crossing, as may be used in some embodiments. When the user's hand motion crosses boundary plane 1510c as well as either, or both, of boundary planes 1510a and 1510b (e.g., as shown by the vector 1555d) then the default angle values may be used for each of angles 1530a-d. The default angles may be suitable as a hand crossing both horizontal and vertical boundary planes may be equally likely to have been intended by the user as either a generally vertical or horizontal swipe.

FIG. 15F is a schematic diagram illustrating placement of a gesture box relative to a user's shoulder 1515b, as may occur in some embodiments. Alignment to the user's shoulder, where the user's upper arm will rotate during the swipe, may acquire more meaningful data than other regions. As discussed elsewhere herein, the gesture box may follow the rotation of the user's torso or shoulder point.

### Example Gesture Detection and Usage Pipeline

As discussed above, the system may recognize a gesture based, at least in part, upon the user's motions during the action phase. However, if the gesture is not yet known, it may be difficult to identify the beginning and end of this phase, particularly as the conditions for the action phase of one gesture may not be the same as the conditions for another.

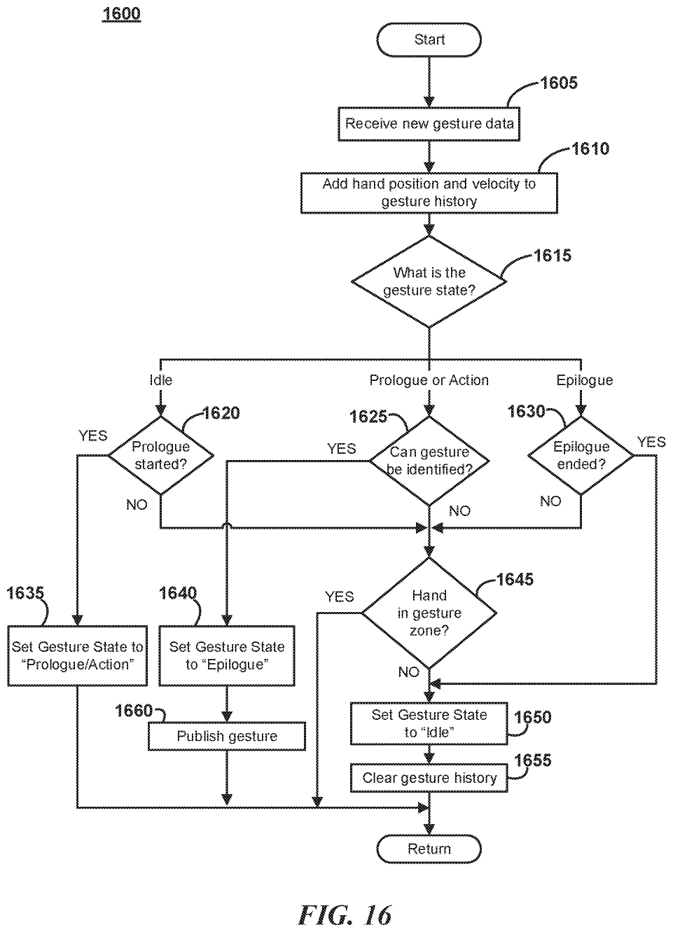

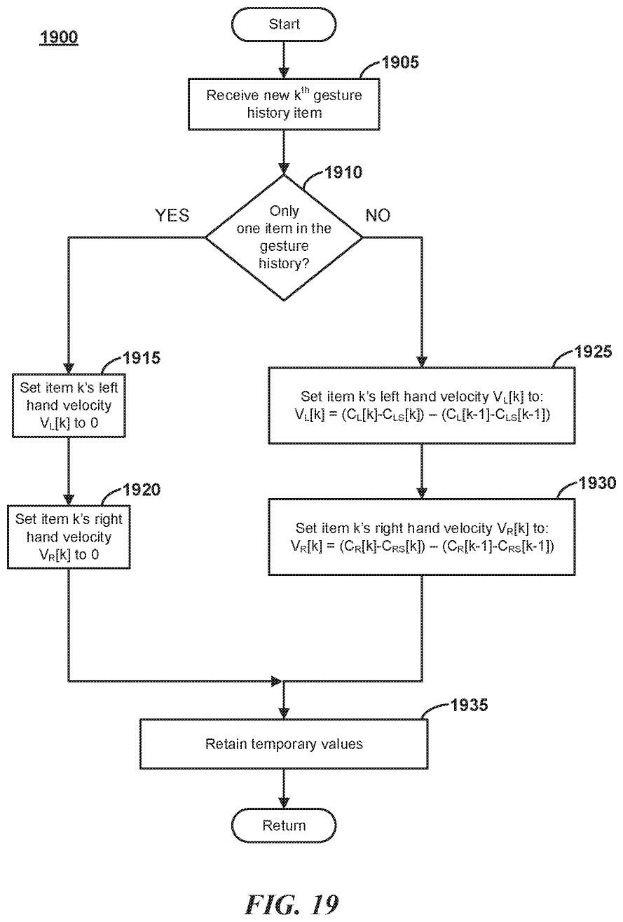

FIG. 16 is a flow diagram illustrating operations in an example gesture history management process 1600 as may be implemented in some embodiments, address this difficulty, at least in part. For example, gesture recognition at block 1050 may employ the process 1600, including heuristics, e.g., in-zone transitions and boundary crossings, at block 1625. At block 1605, the system may receive new gesture data, e.g., the classified data from a depth frame from classification operations 1015. At block 1610, the system may add the hand position in the frame and velocity to the gesture history. The gesture history may be a stack of gesture data for each frame received in succession (an example is discussed with reference to FIG. 19).

At block 1615, the system may determine the gesture state. In some embodiments, the gesture state may be represented as an integer variable number, e.g., 0-2 where: 0=Idle; 1=Prologue/Action; 2=Epilogue (though again, one will appreciate alternative possible classifications that, e.g., distinguish only between movements related and not related to the user's intent). Accordingly, determining the gesture state in block 1615 may simply involve determining the present integer value of a state variable as it was updated at blocks 1635, 1640 and 1650 (initially, the variable may be in the “Idle” state). If the system determines that the state is “Idle,” then the system may determine if a gesture's prologue has started at block 1620. If the system determines that the prologue has begun at block 1620, then the system may set the gesture state to “Prologue/Action” at block 1635. If the prologue has not started at block 1620, then the system may determine if the user's hand is in the gesture zone at block 1645. If the user's hand is in the gesture zone, then the process may return in anticipation of receiving new gesture data. Conversely, absence of the hand in the zone may indicate that the gesture has concluded. Consequently, at block 1650, the system may set the gesture state to “Idle” and may clear the gesture history at block 1655 in anticipation of a new gesture.

If, at block 1615, the system instead determines that the gesture is in the prologue phase or the action phase, then at block 1625 the system may determine if the gesture can be identified based upon the available data in this frame and the gesture history. If the gesture can be identified, then the system may set the gesture state to “Epilogue” at block 1640. The identified gesture may also be published for consumption by any listening applications at block 1660.

Block 1640 will result in this system determining in a subsequent iteration for a new frame that the gesture is in the epilogue phase, e.g., at block 1615. If the system then determines that the epilogue has ended at block 1630, then the system may transition to block 1650. To summarize, the example process depicted here transitions to the Idle state either when: the user retracts their hand from the gesture zone (a “NO” transition from block 1645); or the user's hand is in the gesture zone, but is moving away from the user's body (a determination that the Epilogue has ended at block 1630). As discussed above, one gesture may follow immediately upon another, so in some instances the next frame may result in a new prologue for the next gesture.

The system may detect the epilogue end transition in one of two methods in some embodiments. In the first method, the system simply concludes the epilogue once the user's hand exits the gesture zone. The second method relies on the expectation that the user will retract their hand in the epilogue. Thus, if the system observes the hand extending further into the gesture zone, it may construe the act as the prologue to a subsequent gesture, rather than an epilogue to the most recent gesture. When this occurs, the system may immediately clear the gesture history and set the gesture state to Idle. This may facilitate the system's recognition of subsequent gesture entries as the start of the prologue in block 1620 and proceed to identify this subsequent gesture.

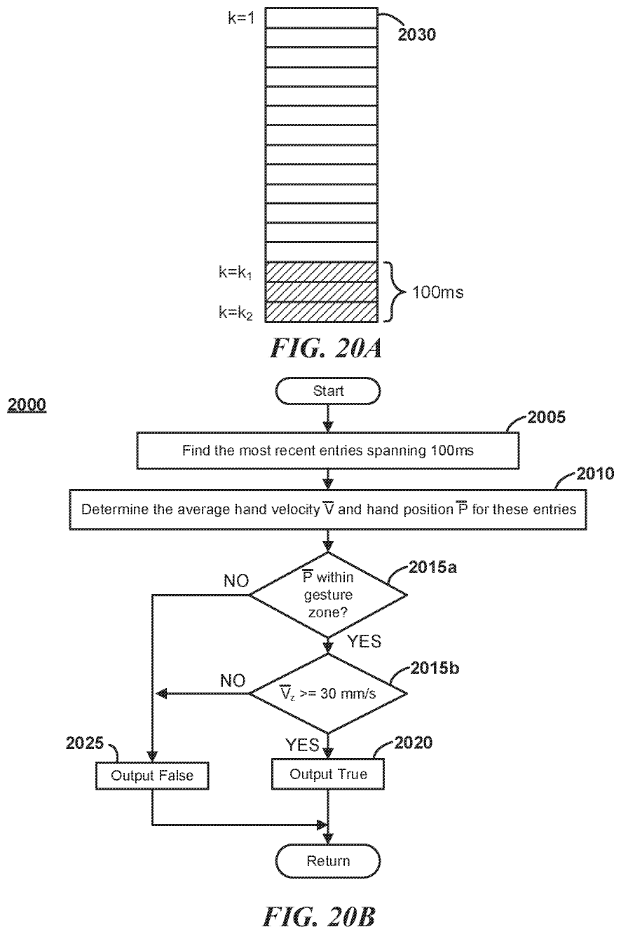

Prologue detection is discussed in greater detail herein in relation to the example of FIG. 20B.

### Example Gesture Detection and Usage Pipeline—Swipe Direction Boundaries

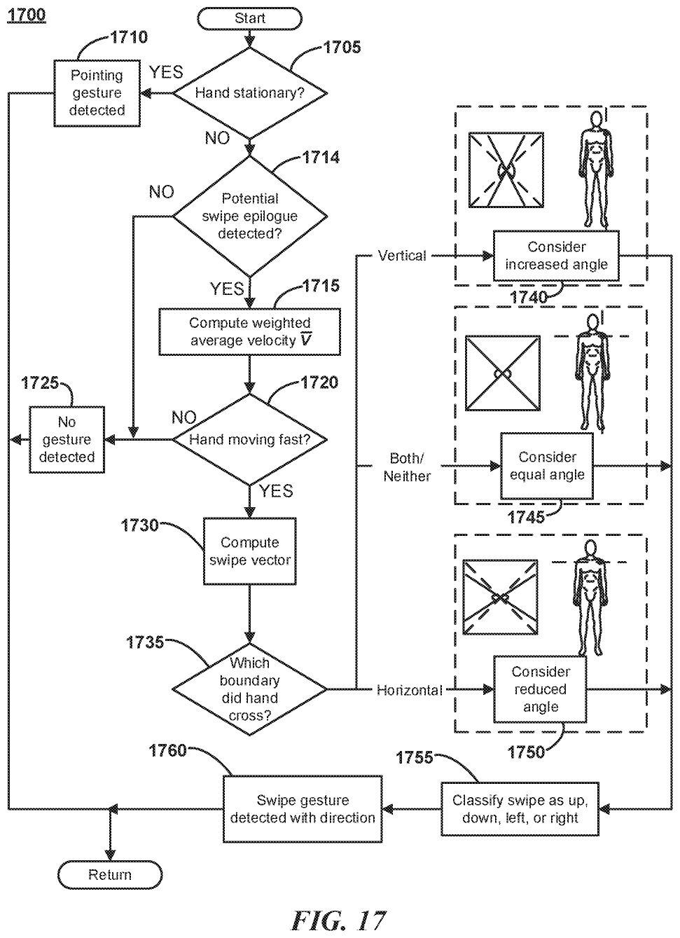

FIG. 17 is a flow diagram illustrating various operations in an example gesture detection process 1700 as may be implemented in some embodiments. For example, the process 1700 may be used in block 1625.

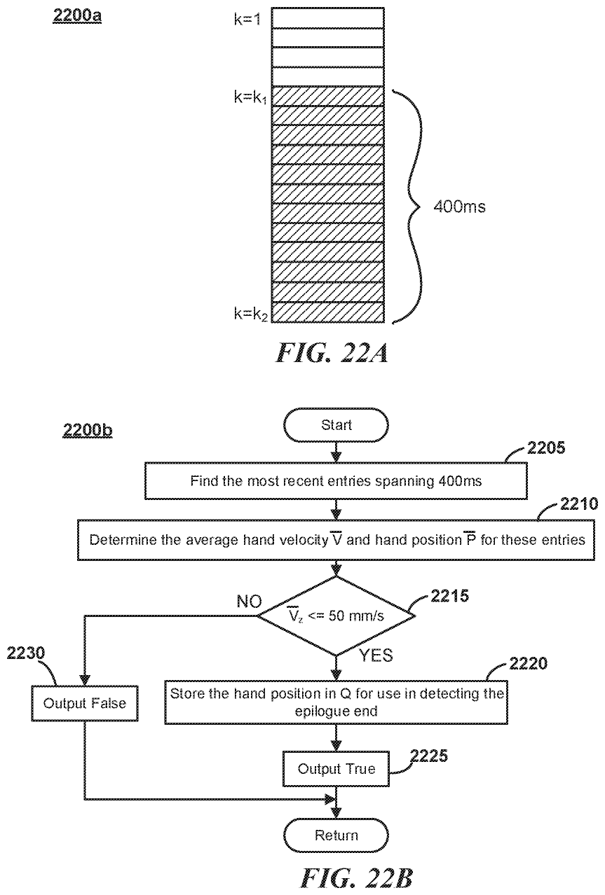

At block 1705, the system may determine if the user's hand is stationary. For example, the system may determine if the average speed of the user's hand over the past several frames has been below a threshold. If the system determines that the user's hand is stationery, then the system may determine that a pointing gesture has been detected at block 1710. An example of this determination is provided below with reference to FIGS. 22A and 22B. Based upon this determination, the system may transition to block 1640 and publish the gesture at block 1660.

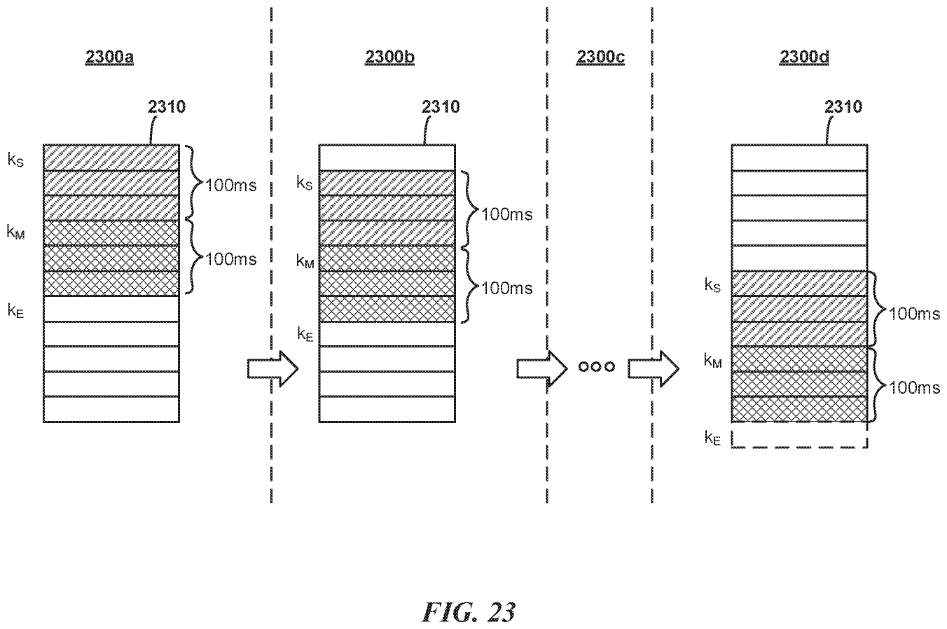

If the system does not determine that the hand is stationary, then the system may transition to block 1714 and estimate whether a swipe epilogue end detection will be likely at block 1630. An example process by which this estimation may be accomplished is described in greater detail below with respect to FIGS. 23 and 24. If an epilogue end is not likely, the system may transition to block 1725 and continue to delay the publication of any new gesture (e.g., return “no” at block 1625). In contrast, if the epilogue end seems likely, the system may transition to block 1715 and calculate a weighted average velocity V̅.

The weighted average velocity V may be defined as shown in Equation 1:

$$\overline{V} = \frac{{\sum }_{i = 1}^{T} {w}_{i} {v}_{i}}{{\sum }_{i = 1}^{T} {w}_{i}} \qquad ( 1 )$$

where vᵢ is the velocity of the hand at timestep i, wᵢ is the weight of the velocity sample, and T is the present time. In some embodiments, wᵢ is the distance of the hand from the body (though, again, in some embodiments, no weights may be applied). Accordingly, the further the user's hand is from the user's body, the more influence vᵢ at that moment has on V̅. The summation shown here is over the entirety of the available gesture history buffer (from the first entry until the present T^{th} entry). Where the gesture history buffer is a circular buffer, this period may only be for some range into the past (e.g., the past four seconds). For longer buffers, or for large buffers which are not circular buffers, the summation may be over only the most recent entries within a range (e.g., two seconds).

At block 1720, the system may determine if the hand is moving “quickly” or “slowly,” e.g., by comparing the weighted average velocity V̅ to a threshold, such as a threshold determined to be the minimum speed associated with a swipe gesture. For example, if ∥V̅∥>=250 mm/s, then the system may proceed to block 1730 (∥V̅∥ is the Euclidean distance of V̅). A V̅ value below the threshold may be construed as “slow” and a value at or above as “quick.” If the hand is not moving quickly, then at block 1725 the system may indicate that no gesture has been detected (e.g., withhold any new publication regarding identified gestures). In this instance, the system may transition to block 1645 as discussed above.

When the hand is moving sufficiently fast to be a swipe gesture, then the system may determine the swipe vector at block 1730. In some embodiments, the swipe vector is the difference between the end and beginning centroid positions of the user's hand in the action or action and prologue phases. The system may use gesture samples since the prologue started until the current frame. In some embodiments, the swipe vector may instead be determined from the average velocity V̅ during these phases. To clarify, e.g., whether a boundary (e.g., 1510b) was crossed may be determined by considering successive hand positions in the gesture history, but the angle used for adjusting division angles (e.g., 1530a-d) may be determined using V̅. Particularly, the computation of the swipe vector angle at block 1730 may be determined using the equation

$$α = {tan}^{- 1} \frac{{\overline{V}}_{y}}{{\overline{V}}_{x}} \qquad ( 2 )$$

where V̅ₓ and V̅_{y} are the x and y components of V̅ respectively.

At block 1735, the system may determine which boundary or boundaries the vector crosses (or if no boundary was crossed, though in some embodiments, a boundary crossing may be a requirement to transition from block 1720 to block 1730). As discussed with respect to FIG. 15, if the vector crosses only a vertical boundary (one of boundary 1510a or boundary 1510b), then at block 1740, the system may consider increased angles for the LEFT and RIGHT regions, as in the situation of FIG. 15C. Similarly, if the vector crosses only the horizontal boundary (e.g., boundary 1510c), then at block 1750 the system may consider increased angles for the UP and DOWN regions, as in the situation of FIG. 15D. If the vector crosses the horizontal boundary (e.g., boundary 1510c) and one or more of the vertical boundaries (e.g., boundaries 1510a and 1510b), then at block 1745, the system may employ the default angles for the regions, as in the situation of FIG. 15E. Using the regions as adjusted, the system may then determine the region in which the vector terminates at block 1755 and classify the swipe gesture accordingly. This may conclude the detection of the swipe gesture as indicated at block 1760, and the results may be published at block 1660 as discussed above.

### Example Gesture History Structure and Usage

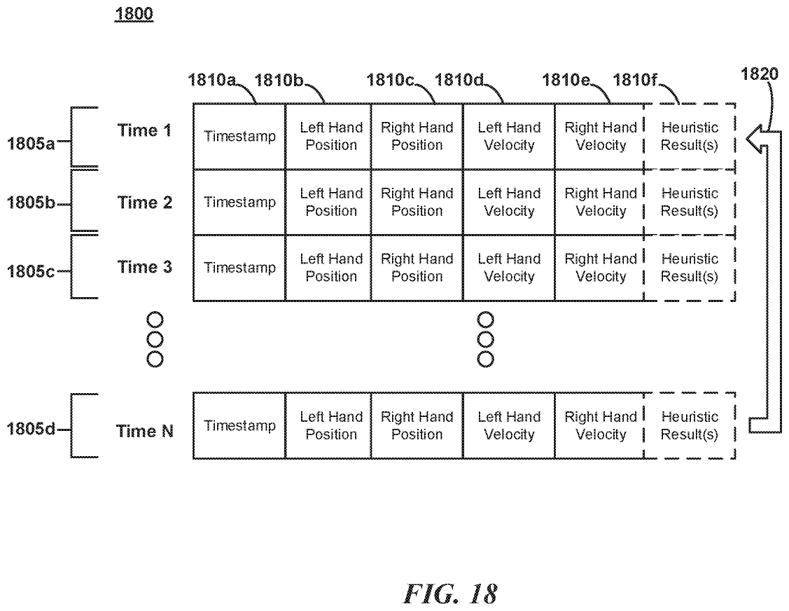

In various embodiments, the gesture history may be stored in a “stack” or “queue,” wherein frame or gesture data is ordered sequentially in time. In some embodiments, the queue may be implemented as a circular queue or circular buffer, as is known in the art, to improve performance. FIG. 18 is a schematic diagram of a gesture history buffer 1800, e.g. a circular buffer, as may be used in some embodiments. The buffer 1800 may consist of a series of entries 1805a-d from a most recent time N (entry 1805d) until a first received entry (1805a). In some embodiments, timestamps may be recorded roughly 60 times every second (an entry approximately every 16.67 milliseconds). Though shown as such here, one will appreciate that the data captures may not be equally spaced in time in some embodiments. The timestamp 1810a may be the time that the gesture entry was recorded following the last clearance of the gesture history.

Each entry may include a timestamp 1810a, a position of the user's left hand 1810b (e.g., a centroid as discussed in greater detail herein), a position of the user's right hand 1810c, a velocity of the user's left hand 1810d, and a velocity of the user's right hand 1810e (e.g., using successive centroid determinations as discussed in greater detail herein). In some embodiments, the gesture history may also include one or more data values 1810f associated with the heuristic results as discussed herein.

Where the buffer 1800 is a circular buffer, the buffer may comprise a finite region of data. As the end of the region is reached with sequential writes, the system may return to the initial entry 1820 and overwrite the oldest entry with the most recent captured data (for example, the capture at a time N+1 may be written at the position 1805a in the buffer that was previously storing the data for time 1). The system may track a reference to the most recent entry's position so that it may read the entries in sequential order.

### Example Centroid and Position Determinations

As discussed elsewhere herein, the centroid of depth values classified as being associated with the user's torso may be used in some embodiments, e.g., to determine the distance from the torso to the user's hand, for placement of the gesture zone, etc. These values may be received as an array of data points D_{T}[i] for i=1 . . . N_{T}, classified as corresponding to the torso. Each point may be a vector, e.g., of (x, y, z) coordinates.

The torso centroid C_{T} may then be computed as:

$${C}_{T} = \frac{1}{{N}_{T}} {\sum }_{i = 1}^{{N}_{T}} {D}_{T} [ i ] \qquad ( 3 )$$

Similar to the torso, the system may receive values classified as being associated with the user's shoulders. The left (or right) shoulder joint centroid may similarly be determined as:

$${C}_{LS} = \frac{1}{{N}_{LS}} {\sum }_{i = 1}^{{N}_{LS}} {D}_{LS} [ i ] \qquad ( 4 )$$

where D_{LS}[i] are those points classified as being associated with the left shoulder (again, one will appreciate alternatives using, e.g., boundary values, estimated offsets, etc.).

Left or right hand positions may similarly be determined as the centroid of their respective depth value collections D_{L}[i] (having N_{L} points) and D_{R}[i] (having NR points). For example, the left hand centroid C_{L} may be calculated as:

$${C}_{L} = \frac{1}{{N}_{L}} {\sum }_{i = 1}^{{N}_{L}} {D}_{L} [ i ] \qquad ( 5 )$$

With these values, relative position of the left hand to the left shoulder may be taken as the difference in the centroids, i.e., P_{L}=C_{L}−C_{LS} for the left hand and P_{R}=C_{R}−C_{RS} for the right.

### Example Hand Velocity Determination

FIG. 19 is a flow diagram illustrating operations in an example gesture history velocity calculation process (e.g., the velocities reflected in positions 1810d and 1810e), as may be implemented in some embodiments. At block 1905, the system may receive the most recent gesture, the k^{th} gesture (if this is the first iteration of the process, this may be the first received gesture). The k^{th} gesture entry is here represented by P_{L}[k] for the left hand position and the right hand position is represented by P_{R}[k]. Naturally, one will appreciate that this example algorithm may be applied to either the left hand or the right hand exclusively. Accordingly, the entry may then be referred to simply as P[k].

If the gesture entry is indeed the first received entry, as determined at block 1910, then at blocks 1915 and 1920, the system may set the velocities for the right and left hand (e.g., the value of the velocities 1810d and 1810e at the position 1805d in the circular buffer during a first iteration) to zero and return until the next gesture is received. At block 1935, any miscellaneous values that may be needed for future computation may be retained, not necessarily in the gesture history, but possibly in registers or variables. For example, the shoulder centroid values C_{LS} and C_{RS} for this k^{th} time may be retained for use at a subsequent k+1 time (the hand centroids may already be retained in the gesture fields 1810b and 1810c for the preceding capture times).

When the next entry is received, since there will already be an item in the history at block 1910, the system will instead transition to blocks 1925 and 1930. As shown in block 1925 the distance from the hand to shoulder at each respective time may be used as a consistent reference for the velocity relative to the user, e.g.:

V_{L}[k]=(C_{L}[k]−C_{LS}[k])−(C_{L}[k−1]−C_{LS}[k−1]) (6)

Note that in some embodiments multiple gesture history values may be received rather than the process run each time. For example, rather than only consider a single previous gesture record when determining the velocity, some embodiments may average the velocity over a window of preceding gesture records.

### Example Prologue Start Detection Method

Prologue detection at block 1620 may proceed in some embodiments with consideration of the hand's relation to the gesture zone. For example, FIG. 20A is a schematic diagram illustration of items in an example gesture history 2030 as may be used in conjunction with the operations of FIG. 20B. FIG. 20B is a flow diagram illustrating operations in example prologue start detection process 2000, as may be implemented in some embodiments.

At block 2005, the system may determine the most recent entries spanning 100 ms in the gesture history 2030. As illustrated, these are the entries between entries k₁ and k₂ inclusive in FIG. 20A (as in the gesture history of FIG. 18, the most recent entries may be at the bottom of the illustrated queue).

At block 2010, the system may determine the average velocity V̅ and average hand position P̅ for these entries.

The average hand position P̅ may be determined as:

$$\overline{P} = \frac{{\sum }_{k = {k}_{1}}^{{k}_{2}} P [ k ]}{{k}_{2} - {k}_{1} + 1} \qquad ( 7 )$$

where P[k] is the hand position (e.g., the centroid) at entry k. Similarly, the averaged velocity V̅ may be calculated as:

$$\overline{V} = \frac{{\sum }_{k = {k}_{1}}^{{k}_{2}} V [ k ]}{{k}_{2} - {k}_{1} + 1} \qquad ( 8 )$$

The system may then return true at block 2020 if both of blocks 2015a and 2015b are satisfied, and false at block 2025 otherwise.

Block 2015a determines whether P is within the gesture zone. Block 2015b instead isolates the z component, V̅_{Z}, of velocity V̅ and asks whether V̅_{Z}>=30 millimeters-per-second. Here, a positive velocity indicates that the hand is moving away from the torso and negative velocity indicates that it is moving towards the torso (e.g., using a coordinate system originating at the shoulder point or torso centroid as discussed herein). Consequently, 30 mm/s implies that the hand is moving at approximately this speed away from the torso.

### Example Swipe Epilogue End Detection Method

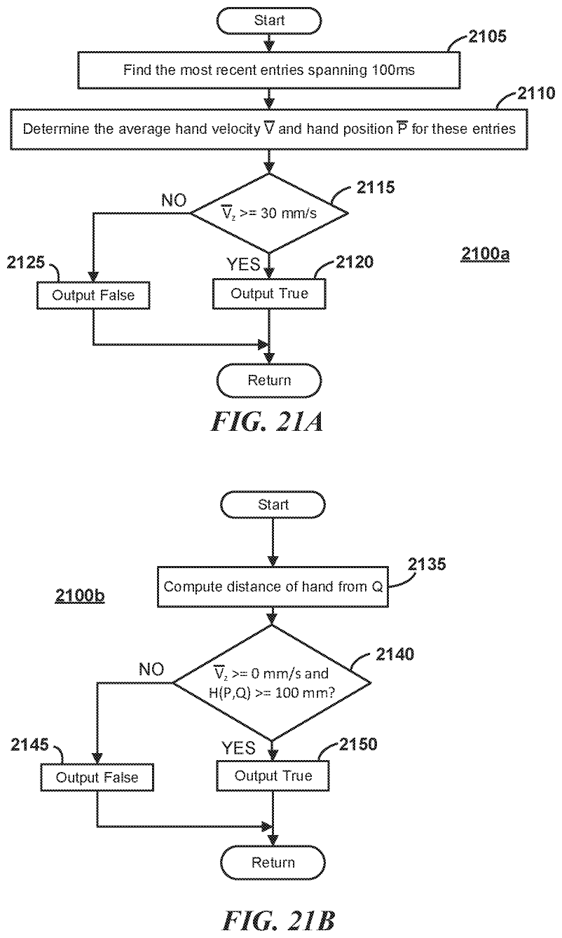

Epilogue detection performed at block 1630 may vary depending upon the gesture identified. With regard to swipe gesture epilogue end detection, similar to the process 2000 of FIG. 20B, FIG. 21A is a flow diagram illustrating operations in an example swipe epilogue detection process 2100a as may be implemented in some embodiments. As with the process 2000, the system may again determine the most recent entries spanning 100 ms in the gesture history at block 2105 and determine the average velocity V̅ and average hand position P̅ for these entries at block 2110. However, in lieu of the conditions 2015a and 2015b, only the condition of 2015b may be required at block 2115 before assessing whether to announce that the swipe epilogue has been detected or not been detected at blocks 2120 and 2125 respectively.

Note the rule V̅_{Z}>=30 mm/s condition of blocks 2015b and 2115 may be used in block 1630 to detect the end of the epilogue and the transition to idle or a new prologue.

### Example Pointing Epilogue End Detection Method

In contrast to the swipe gesture epilogue end detection of FIG. 21A, FIG. 21B is a flow diagram illustrating operations in an example pointing epilogue detection process 2100b (which, again, may be implemented as part of block 1630) as may be implemented in some embodiments. Q here refers to the position of the user's pointing hand after identification that a pointing gesture has begun (e.g., when identified at the beginning of the prologue/action phase, such as the first iteration of 1600 where block 1615 is in “Prologue or Action”, or via the stationary hand determination described below with respect to FIG. 22B). At block 2135, the system may determine the distance from this initial position Q to the present position of the hand P (again, possibly represented as the centroid of the hand). For example, the system may compute the distance H(P,Q) as

H(P,Q)=\sqrt{(P_{X}−Q_{X})²+(P_{Y}−Q_{Y})²+(P_{Z}−Q_{Z})²} (9)

At block 2140, the system may consider this distance H(Q,P) as well as the hand's Z-directional velocity V_{Z} at the time the present position P was captured. If V_{Z}>=0 mm/s and H(P, Q)>=100 mm at block 2140, the system may infer that the user is no longer pointing and consequently that the epilogue phase has concluded, returning true at block 2150 and false otherwise at block 2145.

### Example Stationary Hand Recognition

As mentioned, gesture recognition at block 1625 may proceed as indicated in the process 1700 of FIG. 17. Determination of that hand is stationary at block 1705 may be accomplished with reference to the operations described in FIG. 22A and FIG. 22B. FIG. 22B is a flow diagram illustrating operations in an example stationary hand determination process 2200b, as may be implemented in some embodiments.

At block 2205, the system may find the most recent gesture history entries spanning approximately 400 ms, e.g., as shown between entries k₁ and k₂ in the history 2200a of FIG. 22A. At block 2210, the system may compute the average position P̅ and average velocity V̅ for these entries using Equations 7 and 8, respectively, described above. At block 2215, the system may determine if the Z-directional component of V̅, V̅_{Z} is less than or equal to 50 millimeters per second. If not, the system may determine that the hand is not stationary at block 2230 (and transition to block 1714). In contrast, if the hand is stationary, the system may store the hand position in the variable Q for use in detecting the epilogue end at block 2220. The system may then note that the hand was stationary at block 2225 (and transition to block 1710).

### Example Swipe Epilogue Prediction

As mentioned, in addition to the full consideration of whether a swipe epilogue has concluded at block 1630, the system may also predict whether a swipe epilogue is likely to be detected at block 1714 as part of the gesture recognition process. FIG. 23 is a schematic diagram illustrating successive iterations of a sliding window over items in an example gesture history as may be performed in conjunction with the operations of FIG. 24. FIG. 24 is a flow diagram illustrating operations in an example swipe epilogue prediction process, as may be implemented in some embodiments.

Block 1714 may use a combination of the heuristics to identify the transition from action to epilogue within operations 2400. At block 2405, the system may determine k_{S}, k_{M} and k_{E} as shown in FIG. 24 such that each segment spans approximately 100 ms. Particularly, the gesture history queue 2310 is organized such that the oldest received gesture entry is at the top and the most recently received gesture entry is at the bottom. As discussed, above, this history queue 2310 may be a circular buffer and consequently only reflect a sliding window of the most recently received gesture items.

In an initial iteration 2300a, k_{S} may be set to the first received gesture item, k_{M} to the item after 100 ms and k_{E} to the final item of the 100 ms range following k_{M}. Thus, P̅(k_{S}, k_{M}) corresponds to the average position starting from the entry k_{S} (inclusive) until the entry just before k_{M} (exclusive). Let k_{E} be the item just after the second 100 ms so that P(k_{M}, k_{E}) is computed from the entry k_{M} (inclusive) until the entry just before k_{E} (exclusive). The position k_{E} is shown outside the history at final iteration 2300d to facilitate understanding (and k_{M} is similarly exclusive of the first 100 ms set), but one will appreciate that any suitable method may be used to identify the appropriate 100 ms range of entries. Similarly, the 100 ms range is used here to facilitate understanding, and one will appreciate that substantially similar values, before more or less than 100 ms, may be used instead.

As will be discussed with reference to block 2425, the positions of k_{S}, k_{M} and k_{E} may be incremented with each iteration. Thus, at the time of the second iteration 2300b, each of k_{S}, k_{M} and k_{E} may be lowered to a more recent entry. This process may continue through successive iterations 2300c until a final iteration 2300d wherein k_{E} exceeds the last entry (corresponding to block 2430).

During each iteration the system may compute the average positions P̅(k_{S}, k_{M}) and P(k_{M}, k_{E}) for the collection of entries within the k_{S} to k_{M} range and k_{M} to k_{E} range respectively, at block 2410. The system may then determine whether any of the boundary crossings have occurred at each of blocks 2415a-d and record a corresponding crossing at each of blocks 2420a-d.

Note that in some embodiments, position coordinates may be considered relative to the shoulder point for the hand under consideration (e.g., the origin of the coordinate system is the shoulder joint). Consequently, a positive or negative x-value indicates a position on each side of the crossing boundary plane.

Note that if none of the crossing conditions are satisfied at blocks 2415a-d, that the system may transition to block 2430 without recording any crossings. Where a crossing is detected, it is stored for future reference, e.g., in a crossing array (though one will appreciate that any suitable storage structure may suffice). The process may continue through successive iterations until k_{E} is such that the second 100 ms range includes the most recently received gesture item (corresponding to iteration 2300d) at block 2430.

At this point, the system may consider a plurality of criteria in conjunction with decision blocks 2435a-c and 2445. Particularly, if at least two iterations included crossings then block 2435a may transition to block 2450. At block 2435b, the system may confirm that the crossings satisfy directionality criteria. For example, if the last two entries of the crossing array contain crossings in opposite directions (e.g., one entry shows a crossing from right-to-left and then the other shows a crossing from left-to-right) the system may transition to block 2450, as it is unlikely that a swipe gesture epilogue would include such behavior. In contrast, if a directionality condition that this not occur is satisfied, then the system may transition to block 2435c.

At block 2435c, the system may consider whether various torso relations are satisfied. For example, the system may consider whether the hand's distance for the first crossing is further away from the torso than the hand's distance for the second crossing. If this is not true, the system may transition to block 2450.

If blocks 2435a-c are satisfied, then the system may output true at block at block 2455. In contrast, if any of blocks 2435a-c are not satisfied, then at block 2440, the system may determine the average hand position when k_{E} is at the end of the gesture history, that is, by averaging all the values between k_{S} and k_{E} at the final iteration. If the averaged hand position is outside the gesture zone, the system may transition to block 2455. Conversely, if the values remain within the zone, then the system may transition to block 2450.

At block 2450 the system may indicate that no swipe epilogue has been predicted (e.g., transitioning to block 1725). At block 2455, in contrast, the system may indicate that a swipe epilogue has been predicted (e.g., transitioning to block 1715).

### Example Weighted Average Velocity Determination

The following description provides an example realization of the hand position relative to the user's torso heuristic 1110 discussed above. At block 1715, the system may compute the weighted average velocity V_{AVG} or V̅ as follows

$$\overline{V} = \frac{{\sum }_{k = 1}^{K} W [ k ] V [ k ]}{{\sum }_{k = 1}^{K} W [ k ]} \qquad ( 10 )$$

where W [k] is:

$$W [ k ] = \{ \begin{matrix}\frac{{P}_{z} [ k ] - {d}_{min}}{{d}_{min}} & if {P}_{z} ( k ) is inside the gesture zone \\ 0 & otherwise\end{matrix} \qquad ( 11 )$$

and where P_{z}[k] is the distance of the hand from the torso (e.g., the torso centroid) and dₘᵢₙ is the minimum depth of the gesture zone (e.g., determined empirically). For example, a user whose torso centroid is 1170 mm from the ground may have a dₘᵢₙ=200 mm. That is, these example numbers correspond to the above-discussed embodiment wherein the user's torso centroid form the ground is used as a proxy for the user's height in placement of the gesture box. For taller users whose torso centroid is higher above the ground, then dₘᵢₙ will be larger. Conversely, for shorter users whose torso centroid is closer to the ground, dₘᵢₙ will be smaller. One will appreciate variations where other methods are used (e.g., the centroid of a shoulder classification).

Additionally, one will appreciate that Equation 10 is simply the more general Equation 1 in the form of gesture history entries specifically. Also note that W[k] is zero only if the hand is outside the gesture zone. Thus, in some embodiments, in order for the system to transition from idle to prologue/action, the gesture history must contain some entries with the hand inside the gesture zone (i.e., at least one non-zero W[k]).

Further note that the condition in Equation 11 that P_{z}[k] be inside the gesture zone implies that P_{z}[k]>=dₘᵢₙ and so W[k] is always non-negative. Equation 11 sets W[k]=0 when the hand is outside of the gesture zone so that the corresponding velocity V[k] is not used in the calculation of V when P_{z}[k]<dₘᵢₙ. Conversely, when P_{z}[k]>=dₘᵢₙ, and the hand is within the gesture zone, the values should be considered. The larger the value of dₘᵢₙ, the further away the hand is from torso. W[k] is correspondingly larger when dₘᵢₙ is larger, giving V[k] more influence on V̅.

Because dₘᵢₙ adapts to the user's height (or arm length in some embodiments), the weight W[k] may also adapts to the user's height or arm length. The weight W[k] may also work regardless of whether a person swipes with an outstretched arm or in a more relaxed position closer to their torso.

### Example Boundary Crossing Elaboration Method

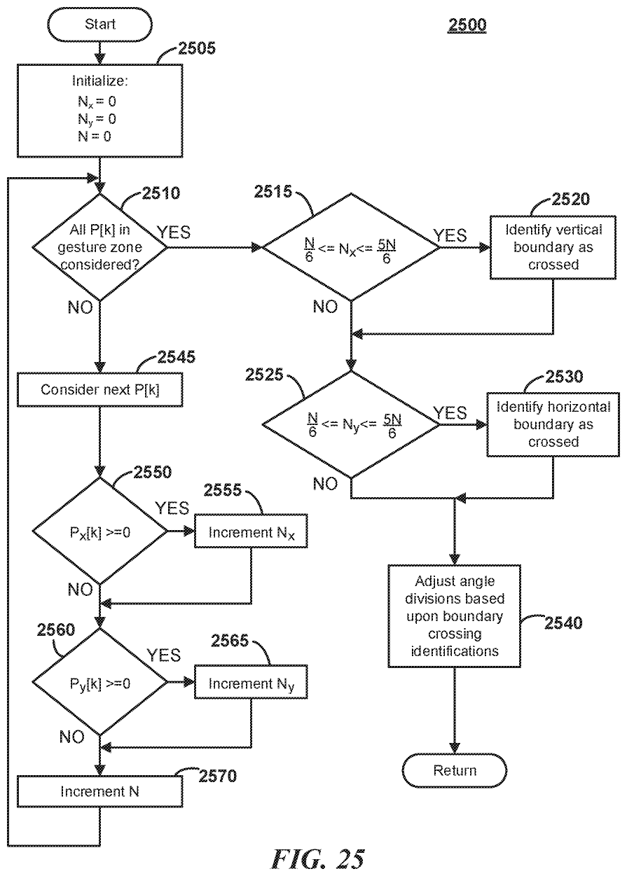

FIG. 25 is a flow diagram illustrating operations in an example boundary consideration process 2500, as may be implemented in some embodiments. Particularly, FIG. 25 elaborates upon the operations that may be performed at each of blocks 1735, 1740, 1745, 1750, 1755, 1760.

At block 2505, the system may initialize each of the counter variables Nₓ, N_{y}, and N to zero. At block 2510, the system may then begin iterating through each P[k] 2545 in the gesture zone. Again, P[k] here represents the position of the hand at the k^{th} entry of the gesture history. Iteration over all k values, accordingly corresponds to iteration over the entire gesture history.

For each position value P[k], the system may determine if the value's x component is greater than zero at block 2550 and increment the counter Nₓ at block 2555. Similarly, if the value's y component is greater than zero at block 2560, then at block 2565 the system may increment the counter N_{y}. The counter N may be incremented regardless of the component values at block 2570.

Once all the values within the gesture zone have been considered at block 2510, then the system may assess boundary crossings based on the values of the counter variables Nₓ and N_{y}. Particularly, if Nₓ is between one and five-sixths of N at block 2515, a vertical boundary crossing may be noted at block 2520. Similarly, if N_{y} is between one and five-sixths of N at block 2525, a horizontal boundary crossing may be noted at block 2530.

Thus, these calculations may be used to determine if the hand crossed the vertical or horizontal boundary. In principle, this may mean that Nₓ=0 or Nₓ=N. But because the hand positions may be noisy, a small number of hand positions may cross the boundary due to a noisy depth sensor. If the user gestures close to the boundary, the hand may also inadvertently cross the boundary.

Accordingly, some embodiments require that the number of hand samples on both sides of the boundary be above a threshold before declaring that the hand has crossed the boundary. For example, the threshold may be one-sixth of N. This threshold may be lower or higher depending upon how deliberate the swipe gesture must be in order to declare that it has crossed the boundary.

As discussed herein, once the boundary crossings have been determined then the division angle may be adjusted at block 2540 (e.g., increasing angles 1530a and 1530b, increasing angles 1530c and 1530d, or leaving all the angles equal). One will appreciate that these operations may be performed as part of blocks 1735, 1740, 1745 and 1750.

### Example Heuristic Applications to Machine Learning

Various embodiments may incorporate some or all of the heuristics described herein into machine learning methods for gesture recognition (e.g., processing by a neural network, support vector machine, principal component analysis, etc.). For example, the Gesture Zone, distance from the user's hand to their torso, and hand motion relative to the swipe axes may be appended to feature vectors when training and testing.

In some embodiments, the machine learning method may be able to adequately identify test gesture histories when provided with large training gesture history datasets. However, incorporation of one or more of the heuristics into the machine learning process may reduce the size of the training data necessary to achieve the same accuracy. Reducing the necessary size of training data may be useful as obtaining correctly labeled and unbiased training data may be difficult or expensive.

Some of the heuristics may be particularly beneficial for this purpose as the heuristics may incorporate prior knowledge regarding the problem domain into the machine learning method. For example, in contrast to a “generic” machine learning dataset, handcrafted feature vectors exhibit a more direct mapping to the desired outcome. In addition, the heuristics artificially augment the limited training data, creating more “value” for each training data item. That is, handcrafting feature vectors may save the machine learning system some work in learning these features from training data.

In some embodiments, machine learning feature vectors may be extended to include: left (or right) hand position relative to the left (or right) shoulder joint as part of the boundary heuristic; left (or right) hand velocity relative to the left (and right) shoulder joint as part of the boundary heuristic; and a weight W derived from the distance from the user's torso P_{z} and the start of the gesture zone dₘᵢₙ.

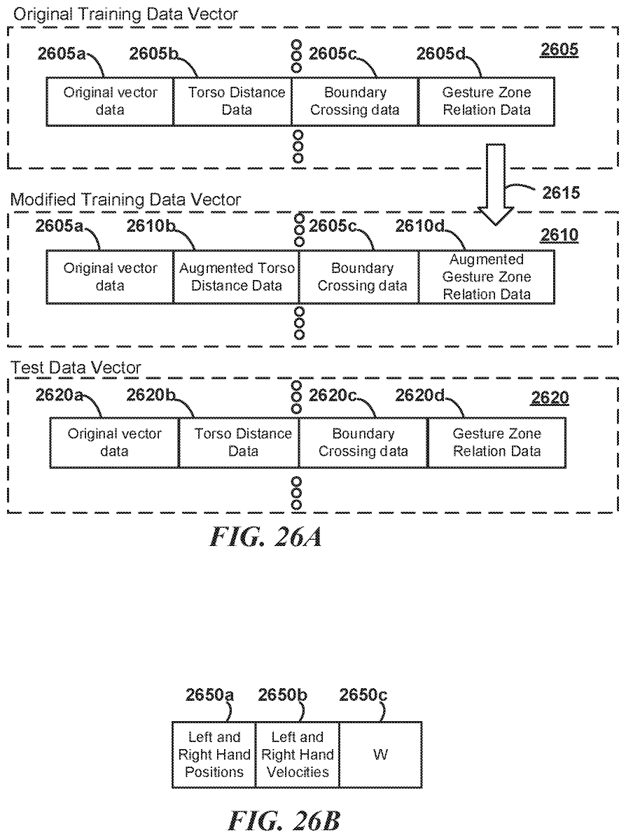

As an example, to facilitate understanding, FIG. 26A is a schematic illustration of training and test feature vector datasets as may be used in some embodiments. Particularly, original training data may include a series of vectors 2605a (e.g., including a series of hand positions over time and a known classification with a performed gesture or no gesture). Note that the original data 2605a may simply be gesture history entries as discussed above in FIG. 18 without heuristic components 1810f. In some embodiments, data 2605a may simply comprise a timestamp and a left/right hand position relative to the torso centroid.

To this original data 2605a may be appended vector data associated with the torso distance heuristic 2605b (e.g., V as determined in Equation 10, the boundary crossing 2605c, P̅(K_{S}, K_{M}) and P̅(K_{S}, K_{E}), and the hand position's relation to the gesture zone 2605d, to form a new set of original training feature vectors 2605. Again, note that in some embodiments the hand position may be assessed relative to the shoulder point or torso centroid.

Thus, the augmented training data vector may include: a timestamp; left/right hand position relative to shoulder point; left/right hand velocity; V̅; weight W associated, e.g., with distance heuristic 2605b; boundary crossing P̅(K_{S}, K_{M}) and P̅(K_{S}, K_{E}); and Gesture zone data 2605d. Naturally, training data vectors will also be associated with a known gesture classification.

The training data may be further enlarged by creating additional modified training vectors 2610 by augmenting 2615 either or both of torso 2605b and gesture zone data 2605d with augmented values 2610b and 2610d respectively. For example, the data values may be scaled using the scaling method discussed below. In this example, the boundary crossing data 2605c and original vector data 2605a may remain the same in the modified training vectors 2610. In some embodiments, the original data may be augmented as well. For example, when the hand positions are modified using Equations 12-14, the hand position and velocities may be updated so as to correspond with swipes of a different size.

The corresponding values 2620a-d in the test data 2620 (e.g., data acquired in-situ during actual interactions with the system) may be acquired in a fashion analogous to original data 2605, without the modifications 2615.

### Example Heuristic Applications to Machine Learning—Data Scaling

Some embodiments may augment the training data (e.g., as part of modifications 2615) by scaling hand positions from their original point P_{Z}[k] to a new point P′_{z}[k]:

P′_{z}[k]=P_{z}[k]*A (12)

where a scaling factor A<1 brings the hand gesture position closer to the torso and A>1 brings the hand gesture position further away. Such scaling may facilitate the creation of dataset variations from a single training dataset, e.g., to avoid overfitting. The system may similarly consider larger or smaller swipes by scaling values perpendicular to the screen or torso, e.g.:

P′ₓ[k]=Pₓ[k]*B (13)

P′_{y}[k]=P_{y}[k]*B (14)

where B<1 makes the gesture smaller and B>1 makes the gesture larger.

Some embodiments may further augment the training data by creating faster or slower swipes. Such speed adjustment may be accomplished by adjusting the timestamp t that a gesture sample was received. This can be done by scaling

t′=t*L (15)

where L<1 speeds up the swipe and L>1 slows down the swipe.

### Example Heuristic Applications to Machine Learning—Example Feature Vector

FIG. 26B is a schematic diagram illustrating elements in an example feature vector as may be used for machine learning applications in some embodiments. Particularly, alternatively, or in conjunction, with the feature vectors of the training and test sets of FIG. 26A, some embodiments contemplate a vector having a portion 2650a indicating the positions of the user's hand (left, right, or both) throughout a gesture, a portion 2650b indicating the velocities of the use's hand (left, right, or both) throughout the gesture, and a portion 2650c with a weight value, created, e.g., using the method of Equation 11.

### Computer System

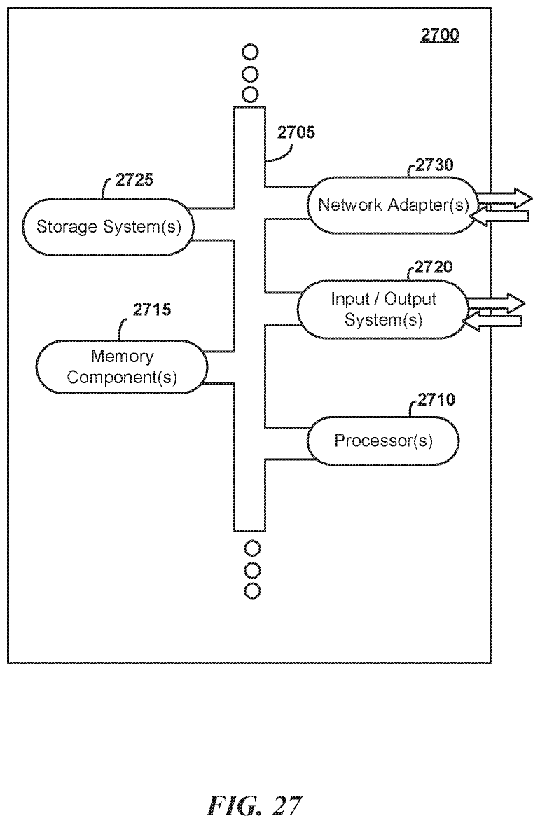

FIG. 27 is a block diagram of an example computer system as may be used in conjunction with some of the embodiments. The computing system 2700 may include an interconnect 2705, connecting several components, such as, e.g., one or more processors 2710, one or more memory components 2715, one or more input/output systems 2720, one or more storage systems 2725, one or more network adaptors 2730, etc. The interconnect 2705 may be, e.g., one or more bridges, traces, busses (e.g., an ISA, SCSI, PCI, I2C, Firewire bus, etc.), wires, adapters, or controllers.

The one or more processors 2710 may include, e.g., an Intel™ processor chip, a math coprocessor, a graphics processor, etc. The one or more memory components 2715 may include, e.g., a volatile memory (RAM, SRAM, DRAM, etc.), a non-volatile memory (EPROM, ROM, Flash memory, etc.), or similar devices. The one or more input/output devices 2720 may include, e.g., display devices, keyboards, pointing devices, touchscreen devices, etc. The one or more storage devices 2725 may include, e.g., cloud based storages, removable USB storage, disk drives, etc. In some systems memory components 2715 and storage devices 2725 may be the same components. Network adapters 2730 may include, e.g., wired network interfaces, wireless interfaces, Bluetooth™ adapters, line-of-sight interfaces, etc.

One will recognize that only some of the components, alternative components, or additional components than those depicted in FIG. 27 may be present in some embodiments. Similarly the components may be combined or serve dual-purposes in some systems. The components may be implemented using special-purpose hardwired circuitry such as, for example, one or more ASICs, PLDs, FPGAs, etc. Thus, some embodiments may be implemented in, for example, programmable circuitry (e.g., one or more microprocessors) programmed with software and/or firmware, or entirely in special-purpose hardwired (non-programmable) circuitry, or in a combination of such forms.

In some embodiments, data structures and message structures may be stored or transmitted via a data transmission medium, e.g., a signal on a communications link, via the network adapters 2730. Transmission may occur across a variety of mediums, e.g., the Internet, a local area network, a wide area network, or a point-to-point dial-up connection, etc. Thus, “computer readable media” can include computer-readable storage media (e.g., “non-transitory” computer-readable media) and computer-readable transmission media.

The one or more memory components 2715 and one or more storage devices 2725 may be computer-readable storage media. In some embodiments, the one or more memory components 2715 or one or more storage devices 2725 may store instructions, which may perform or cause to be performed various of the operations discussed herein. In some embodiments, the instructions stored in memory 2715 can be implemented as software and/or firmware. These instructions may be used to perform operations on the one or more processors 2710 to carry out processes described herein. In some embodiments, such instructions may be provided to the one or more processors 2710 by downloading the instructions from another system, e.g., via network adapter 2730.

### Remarks

The drawings and description herein are illustrative. Consequently, neither the description nor the drawings should be construed so as to limit the disclosure. For example, titles or subtitles have been provided simply for the reader's convenience and to facilitate understanding. Thus, the titles or subtitles should not be construed so as to limit the scope of the disclosure, e.g., by grouping features which were presented in a particular order or together simply to facilitate understanding. Unless otherwise defined herein, all technical and scientific terms used herein have the same meaning as commonly understood by one of ordinary skill in the art to which this disclosure pertains. In the case of conflict, this document, including any definitions provided herein, will control. A recital of one or more synonyms herein does not exclude the use of other synonyms. The use of examples anywhere in this specification including examples of any term discussed herein is illustrative only, and is not intended to further limit the scope and meaning of the disclosure or of any exemplified term.

Similarly, despite the particular presentation in the figures herein, one skilled in the art will appreciate that actual data structures used to store information may differ from what is shown. For example, the data structures may be organized in a different manner, may contain more or less information than shown, may be compressed and/or encrypted, etc. The drawings and disclosure may omit common or well-known details in order to avoid confusion. Similarly, the figures may depict a particular series of operations to facilitate understanding, which are simply exemplary of a wider class of such collection of operations. Accordingly, one will readily recognize that additional, alternative, or fewer operations may often be used to achieve the same purpose or effect depicted in some of the flow diagrams. For example, data may be encrypted, though not presented as such in the figures, items may be considered in different looping patterns (“for” loop, “while” loop, etc.), or sorted in a different manner, to achieve the same or similar effect, etc.

Reference herein to “an embodiment” or “one embodiment” means that at least one embodiment of the disclosure includes a particular feature, structure, or characteristic described in connection with the embodiment. Thus, the phrase “in one embodiment” in various places herein is not necessarily referring to the same embodiment in each of those various places. Separate or alternative embodiments may not be mutually exclusive of other embodiments. One will recognize that various modifications may be made without deviating from the scope of the embodiments.

We claim:

1. A computer system comprising:
at least one processor;
at least one memory comprising instructions configured to cause the computer system to perform a method comprising:
receiving a frame of depth data;
determining a portion of the depth data associated with a user's hand;
determining a position of the portion of the depth data associated with the user's hand relative to a gesture zone;
determining a vector, at least in part, by comparing a present position of a portion of the user's hand with a previous position of the user's hand;
determining that the vector crosses a boundary plane;
in response to the vector crossing the boundary plane, adjusting an angle associated with a direction division;
determining that an angle of the vector falls within the angle associated with the direction division; and
publishing a swipe gesture and the direction.

2. The computer system of claim 1, wherein receiving the frame of depth data comprises receiving classified depth data, and wherein
determining a portion of the depth data associated with a hand comprises identifying depth data classified as relating to a hand.

3. The computer system of claim 1, wherein the direction divisions comprise UP, LEFT, RIGHT, and DOWN directions.

4. The computer system of claim 1, wherein the plurality of boundaries comprise a vertical planar boundary and a horizontal planar boundary.

5. The computer system of claim 4, wherein both the vertical planar boundary and the horizontal planar boundaries pass through a shoulder position of the user.

6. The computer system of claim 1, the method additionally comprising:
estimating that a swipe gesture epilogue is present in a gesture history by:
iteratively:
sliding two consecutive windows through the gesture history;
determining a first average velocity associated with gesture history components within the first window;
determining a second average velocity associated with gesture history components within the second window; and
incrementing a crossing counter of a plurality of crossing counters based upon component values of each of the first average velocity and the second average velocity;
determining that the plurality of crossing counters satisfy a threshold; and
determining that a centroid of hand classified depth values in a most-recent frame is within the gesture zone.

7. The computer system of claim 6, wherein the windows comprise 100 ms ranges within the gesture history.

8. The computer system of claim 1, wherein determining that the vector crosses a boundary plane comprises:
determining a number of hand-classified depth values within the gesture zone having component values greater than zero;
determining that the number of hand-classified depth values within the gesture zone having component values greater than zero is above a lower bound and below an upper bound, wherein
the lower bound is greater than zero and less that the total number of hand-classified depth values, and wherein
the upper bound is greater than zero and less that the total number of hand-classified depth values; and
adjusting a boundary crossing angle based upon the determination that the number of hand-classified depth values within the gesture zone having component values greater than zero is above the lower bound and below the upper bound.

9. A computer-implemented method comprising:
receiving a frame of depth data;
determining a portion of the depth data associated with a user's hand;
determining a position of the portion of the depth data associated with the user's hand relative to a gesture zone;
determining a vector, at least in part, by comparing a present position of apportion of the user's hand with a previous position of the user's hand;
determining that the vector crosses a boundary plane;
in response to the vector crossing the boundary plane, adjusting an angle associated with a direction division;
determining that an angle of the vector falls within the angle associated with the direction division; and
publishing a swipe gesture and the direction.

10. The computer-implemented method of claim 9, wherein receiving the frame of depth data comprises receiving classified depth data, and wherein
determining a portion of the depth data associated with a hand comprises identifying depth data classified as relating to a hand.

11. The computer-implemented method of claim 9, wherein the direction divisions comprise UP, LEFT, RIGHT, and DOWN directions.

12. The computer-implemented method of claim 9, wherein the plurality of boundaries comprise a vertical planar boundary and a horizontal planar boundary.

13. The computer-implemented method of claim 12, wherein both the vertical planar boundary and the horizontal planar boundaries pass through a shoulder position of the user.

14. The computer-implemented method of claim 9, the method additionally comprising:
estimating that a swipe gesture epilogue is present in a gesture history by:
iteratively:
sliding two consecutive windows through the gesture history;
determining a first average velocity associated with gesture history components within the first window;
determining a second average velocity associated with gesture history components within the second window; and
incrementing a crossing counter of a plurality of crossing counters based upon component values of each of the first average velocity and the second average velocity;
determining that the plurality of crossing counters satisfy a threshold; and
determining that a centroid of hand classified depth values in a most-recent frame is within the gesture zone.

15. The computer-implemented method of claim 14, wherein the windows comprise 100 ms ranges within the gesture history.

16. The computer-implemented method of claim 9, wherein determining that the vector crosses a boundary plane comprises:
determining a number of hand-classified depth values within the gesture zone having component values greater than zero;
determining that the number of hand-classified depth values within the gesture zone having component values greater than zero is above a lower bound and below an upper bound, wherein
the lower bound is greater than zero and less that the total number of hand-classified depth values, and wherein
the upper bound is greater than zero and less that the total number of hand-classified depth values; and
adjusting a boundary crossing angle based upon the determination that the number of hand-classified depth values within the gesture zone having component values greater than zero is above the lower bound and below the upper bound.

17. A non-transitory computer-readable medium comprising instructions configured to cause a computer system to perform a method, the method comprising:
receiving a frame of depth data;
determining a portion of the depth data associated with a user's hand;
determining a position of the portion of the depth data associated with the user's hand relative to a gesture zone;
determining a vector, at least in part, by comparing a present position of apportion of the user's hand with a previous position of the user's hand;
determining that the vector crosses a boundary plane;
in response to the vector crossing the boundary plane, adjusting an angle associated with a direction division;
determining that an angle of the vector falls within the angle associated with the direction division; and
publishing a swipe gesture and the direction.

18. The non-transitory computer-readable medium of claim 17, wherein receiving the frame of depth data comprises receiving classified depth data, and wherein
determining a portion of the depth data associated with a hand comprises identifying depth data classified as relating to a hand.

19. The non-transitory computer-readable medium of claim 17, wherein the direction divisions comprise UP, LEFT, RIGHT, and DOWN directions.

20. The non-transitory computer-readable medium of claim 17, wherein the plurality of boundaries comprise a vertical planar boundary and a horizontal planar boundary.
